(19) United States
(12) Patent Application Publication
(10) Pub. No.: US 2026/0253179 A1
(43) Pub. Date: Aug. 27, 2026

(54) AI-DRIVEN SIGNAL ENHANCEMENT OF LOW-RESOLUTION IMAGES

(71) Applicant: Illumina, Inc., San Diego, CA (US)

(72) Inventors: Yina Wang, San Jose, CA (US); Merek Siu, Alameda, CA (US); Rishi Verma, San Jose, CA (US); Jeffrey Gau, San Mateo, CA (US); Stanley Hong, Palo Alto, CA (US); Anindita Dutta, San Francisco, CA (US); Aathavan Karunakaran, Berkeley, CA (US); Simon Prince, Carlsbad, CA (US)

(73) Assignee: Illumina, Inc., San Diego, CA (US)

(21) Appl. No.: 18/874,967

(22) PCT Filed: Mar. 27, 2024
(86) PCT No.: PCT/US2024/021639

§ 371 Date: Dec. 13, 2024

Related U.S. Application Data
(60) Provisional application No. 63/455,845, filed on Mar. 30, 2023.

(51) Int. Cl. G06T 5/60; G06N 3/045; G06N 3/08; G06T 3/4046; G06T 3/4053

(52) U.S. Cl. CPC G06T 5/60; G06N 3/045; G06N 3/08; G06T 3/4046; G06T 3/4053; G06T 2207/10056; G06T 2207/20081; G06T 2207/20084; G06T 2207/30072

(57) ABSTRACT

AI-driven enhancement of low-resolution images enables sequencing of a nucleic acid material under low-resolution conditions with requisite accuracy and improved cost and operational efficiency. A training set of images obtained under actual or simulated high-resolution and low-resolution conditions is used to train a model to recover enhanced images, as if taken under high resolution conditions, from unenhanced images taken under low resolution conditions.

### CROSS-REFERENCE TO RELATED APPLICATIONS

This application claims priority to U.S. provisional patent application No. 63/455,845, filed Mar. 30, 2023.

### BACKGROUND

The technology disclosed relates to assays for sequencing of a biopolymeric sample in connection with various genomic, exogenomie, transcriptomic, and proteomic analyses, including high-throughput sequencing implemented using Next Generation Sequencing (NGS). Sequencing methodologies for polynucleotide materials on NGS platforms commonly deploy deoxyribonucleic acid (DNA) libraries in which a DNA target (e.g., genomic DNA (gDNA), or complimentary DNA (cDNA)) is processed into fragments and ligated with technology-specific adaptors. NGS workflow using, e.g., a sequence-by-synthesis (SBS) technique, involves loading a DNA library onto a flow cell and hybridizing individual DNA fragments to adapter-specific complimentary oligonucleotides (oligos) covalently bound to the flow cell surface (planar or patterned); clustering the individual fragments into thousands of identical DNA template strands (amplicons) through amplification (e.g., bridge or exclusion); and, finally, sequencing, in which copy strands are simultaneously synthesized and sequenced on the DNA templates using a reversible terminator-based process that detects signals emitted from fluorophore-labeled single bases as they are added round by round to the copy strands. Because the multiple template strands of each cluster have the same sequence, base pairs incorporated into the corresponding copy strands in each round will be the same, and thus the signal generated from each round will be enhanced proportional to the number of copies of the template strand in the cluster.

NGS operates on massively parallel multiplex platforms that can process sequencing volumes of nucleotides in the billions within very short runtimes and at low cost. For example, Illumina's NovaSeq 6000 sequencing system can generate output in the range of 1.6-40 billion paired end reads at a run time ranging between 13 and 44 hours. By comparison, the Human Genome Project, which sequenced the first human genome using capillary sequencing, took around 10 years.

Despite vast improvements in output volume, runtimes, and cost effectiveness, certain operating constraints persist that lock out additional gains in processing efficiency. Both the speed of imaging and the density at which clusters can be packed onto a flow cell determine the throughput and cost of sequencing. For patterned flow cells, nanowells are etched into the substrate surface for optical cluster spacing. The more densely the nanowells can be etched onto the flow cell, the greater the sequencing output per flow cell and reagent kit, and the more cost-effective the sequencing operation. However, nanowell (and cluster) density is extrinsically limited both to a relative smallest near neighbor distance determined by the resolving power of the particular optical instrument and the absolute smallest near neighbor distance of imposed by the Abbe diffraction limit equal to half the wavelength of emitted light (at a Numerical Aperture (NA) value of 1).

High quality detection lenses and other optical components may be implemented to increase resolving power, including use of high Numerical Aperture (NA) objective lenses and sensor enhancements such as charge-coupled device (CCD) or complementary metal oxide semiconductors (CMOS) sensors implementing time delay integration (TDI), However, such implementations are costly, and however optimal the resolving power, efficiency gains via, e.g., nanowell density, cannot be fully realized because the sequencing operation is still limited to image processing within the diffraction limit.

A number of super-resolution methods (SR) have been developed to optimize diffraction limited image processing, including localization-based techniques, confocal scanning imaging-based approaches, and structured illumination microscopy (SIM). SIM is considered one of the most practical SR methods to employ with NGS. Because of its ability to obtain optical detail from diffraction-limited images of closely spaced targets, SIM supports higher density flow cell loading and thus higher throughput. However, SIM and other SR methods come with a number of difficult tradeoffs. For example, the increased number of images required per target and increased computational requirements for SIM reconstruction greatly increase power consumption during a sequencing run compared to conventional microscopy, creating a diseconomy of scale: greater output at increased cost. Moreover, speed is a critical parameter for NGS, so the need to collect six to nine image exposures for a typical SIM implementation, plus the additional time to actuate the motors to shift the phase and angles to obtain the images is undesirable. Lastly, it is well understood that nucleotide targets may become photo-damaged during the exposure cycles of a sequencing run, where repeated exposure may lead to misincorporation of bases during sequencing, depurination/depyrimidination, or hydrolytie deamination and base conversion. SIM requires a many-fold increase in target exposure per cycle (e.g., 6× or 9×) and thus carries increased risk of target damage and resulting read out failures.

For these and other reasons that will become apparent from the present disclosure, there remains a need for enhancement of cost and operational efficiency of NGS and other sequencing platforms while also maintaining, or even improving, system integrity and reliability.

### SUMMARY

The technology disclosed relates to AI-driven enhancement of low-resolution images taken on an optical sequencing system for use, e.g., in a base calling operation using fluorescent labels or other labels or reporters.

The systems and methods herein for AI-driven enhancement of low-resolution images enable sequencing under low-resolution conditions with requisite accuracy and improved cost and operational efficiency. A training set of images obtained under actual or simulated high-resolution and low-resolution conditions may be used to train a model to recover enhanced images, as if taken under high resolution conditions, from unenhanced images taken under low resolution conditions.

In one aspect, systems and methods are described for image processing at low resolving power. Methods are provided for training a model to analytically generate high-resolution images, as if obtained using a high Numerical Aperture (NA) objective, from target signals captured under low resolution. In one example, a set of parameters are trained using a training set of data having paired images of high-resolution images obtained from a biological sample at a high NA and low NA. The trained set of parameters may be configured as one or more filters that enable a production model to recover enhanced images, as if obtained using high Numerical Aperture (NA) objective, from unenhanced images obtained using a low NA objective. Analytical enhancements herein may be implemented in lieu of expensive lens and other optic element upgrades otherwise required to achieve matching resolution.

In another aspect, systems and methods are described for diffraction limited image processing of high-density samples of biopolymeric materials using standard fluorescence microscopy. Methods are provided for training a model to analytically generate high-resolution images from target signals captured under low resolution in lieu of Fourier transform processing associated with Structured Illumination Microscopy. By way of example, a set of parameters can be trained using a training set of data having paired SIM reconstructed high-resolution images and corresponding SIM processed low-resolution images. The trained set of parameters can be configured as one or more filters that enable a production model to recover enhanced images, as if taken under high resolution conditions, from unenhanced images taken under low resolution conditions using conventional (i.e., non-SIM) microscopy. AI-driven resolution enhancement as provided herein requires fewer computational steps than Fourier transform processing and produces images of comparable high-resolution to SIM without the need for multiple structured image exposures per target. In that regard, the systems and methods herein for AI-driven enhancement of low-resolution images enable optimized diffraction-limited imaging comparable to image resolution obtained in SIM and other SR methods, but with faster sequencing times, reduced photo budget, and less complicated equipment.

A system for AI-driven enhanced of low-resolution images consistent with the disclosure can be a computing device. By way of example, the computing device can be an an instrument, such as an optic sequencing device, having a processor implementing one or more trained filters, in which the instrument is configured to obtain, as an input, low-resolution target image data from one or more low-resolution images of a target captured by one or more sensors of an optic imaging system and recover from the low-resolution target image data, via the trained filter, an enhanced resolution image, as an output, for use in base calling.

Certain embodiments provide imaging systems and methods of resolving high density patterned flow cells or random non-patterned flow cells without having/using one or more of SIM, a high-numerical aperture objective, long exposure times, multiple exposures, or combinations thereof. In one aspect, optimized diffraction-limited imaging in accordance with the systems and methods herein support flow cells with increased nanowell density. In certain examples, high density flow cells herein have up to three times the density of nanowells compared to conventional flow cell technology. Certain embodiments provide sequencing methods supported on a patterned flow cell substrate having an increased nano well density. In one example, such an increase may be twice the number of nanowells per area or an increase of about three times the number of nanowells per area. Examples herein provide imaging of flow cells with nanowells having a pitch (center-to-center distance of the nanowell) of about 600 mm or less, about 500 nm or less, 400 nm or less; or about 350 or less; nanowells having a having a diameter of about 350 nm or less, about 325 nm or less, about 300 mm or less; and/or nanowells having a depth of about 350 nm or less, about 300 nm or less, about 250 nm or less, or about 225 nm or less.

### BRIEF DESCRIPTION OF THE DRAWINGS

The patent or application file contains at least one drawing executed in color. Copies of this patent or patent application publication with color drawing(s) will be provided by the Office upon request and payment of the necessary fee. The color drawings also may be available in PAIR via the Supplemental Content tab.

FIG. 1 depicts a schematic view of an example of an imaging system that may be used to detect a biological sample,

FIGS. 2A-C collectively illustrate various image collection techniques for a biological sample,

FIG. 3 shows Moiré fringe formation by using a grating with one dimensional (ID) modulation.

FIG. 4 shows linear equations (1)-(4) for Fourier Transform Analysis.

FIG. 5 is a graphical depiction of the observable and computationally obtained frequency content of a target under structured illumination from modulated raw sequencing images taken at different illumination phases at different angles.

FIG. 6 illustrates a structured illumination microscopy (SIM) imaging system that may utilize spatially structured excitation light to image a target.

FIG. 7 is a schematic diagram of an example system for training a model using a training set of high-resolution and low-resolution images.

FIGS. 8A-D illustrate various imaging techniques for obtaining paired high-resolution and low-resolution images at respective high and low Numerical Aperture (NA).

FIG. 9 illustrates two sample rates of paired image collection in a respective series of image cycles in a sequencing run.

FIG. 10 is a block diagram of an example sequence of operations for training a model to perform AI-driven resolution enhancement using synthetic low-resolution images.

FIG. 11A is a block diagram of an example sequence of operations for training a model to perform AI-driven resolution enhancement using synthetic low-resolution images generated using a degradation model.

FIG. 11B is an illustration of two-channel sample image tiles of a high-resolution image (raw image) and synthetic low-resolution images (convolved image).

FIG. 12 shows equations (1) and (2) for phase matching and summing phase-shifted structured images,

FIG. 13 shows sample two-channel image tiles for training a model to perform AI-driven resolution enhancement of sequencing images captured under structured illumination.

FIG. 14A is a block diagram of an example computing device for training and applying a model for AI-driven resolution enhancement of sequencing images.

FIG. 14B illustrates a schematic diagram of a system environment for training and applying a model for AI-driven resolution enhancement of sequencing images.

FIG. 15 illustrates AI-driven resolution enhancement of sequencing images using a Generative Adversarial Network (GAN).

FIG. 16 illustrates AI-driven enhancement of low-resolution sequencing images using a cycle-consistent GAN

FIG. 17 illustrates AI-driven enhancement of low-resolution sequencing images using an autoencoder having an encoder stage and a decoder stage.

FIG. 18A illustrates a system implementing an SR-Seq model for AI-driven resolution enhancement of sequencing images.

FIG. 18B illustrates an example of an attention block that may be implemented in the SR-Seq generator.

FIG. 18C illustrates another example of an attention block that may be implemented in the SR-Seq generator.

FIG. 19 is a graphical depiction comparing the results of different types of NN-based and non-NN-based algorithms/AI models that have been trained using high resolution/low resolution paired images.

FIG. 20 is a diagram illustrating an example process of producing an enhanced resolution images from low-resolution images captured in a sequencing operation in production.

### DETAILED DESCRIPTION OF THE INVENTION

The following discussion is presented to enable any person skilled in the art to make and use the technology disclosed and is provided in the context of a particular application and its requirements. Various modifications to the disclosed implementations will be readily apparent to those skilled in the art, and the general principles defined herein may be applied to other implementations and applications without departing from the spirit and scope of the technology disclosed. Thus, the technology disclosed is not intended to be limited to the implementations shown but is to be accorded the widest scope consistent with the principles and features disclosed herein. Those of ordinary skill in the art will recognize a variety of equivalent variations on the description that follows.

The following detailed description is made with reference to the figures. Example implementations are described to illustrate the technology disclosed, not to limit its scope, which is defined by the claims. In that regard, disclosure of various implementations for use in connection with sequencing-by-synthesis (SBS) for Next Generation Sequencing (NGS) is meant to illustrate the implementations in the context of a well-known and widely-used sequencing and imaging techniques. Accordingly, various implementations herein have application to any number of other sequencing techniques, including, e.g., real time sequencing; nanopore sequencing; long read sequencing; single-molecule sequencing; stochastic sequencing; amplification-free sequencing; sequencing by ligation; pyrosequencing; and ion semiconductor sequencing. Similarly, various implementations herein have application to any number of optical sequencing systems. For example, embodiments may be configured to perform at least one of fluorescent imaging, epi-fluorescent imaging, and total-internal-reflectance-fluorescence (TIRF) imaging, super resolution imaging, including structured illumination microscopy (SIM). In particular embodiments, the sample imager is or includes a scanning time-delay integration (TDI) system. Furthermore, the imaging sessions may include “line scanning” one or more samples such that a linear focal region of light is scanned across the sample(s). Imaging sessions may also include moving a point focal region of light in a raster pattern across the sample(s). Alternatively, one or more regions of the sample(s) may be illuminated at one time in a “step and shoot” manner.

Sequencing systems as contemplated herein include one or more optical sequencing systems that are configured to acquire image data from target objects. The target objects may be a sample container of support structure having a substrate onto which one or more subject biopolymeric samples are fixed. Flow cells provide a convenient format for supporting sequencing operations as contemplated herein, including, in particular, surface chemistries involved in the capture, amplification, and imaging of analyte constituents of a biological sample on a flow cell surface, including imaging nucleic acid fragments of a sample DNA or RNA library. Flow cell substrates may be unstructured (planar) or structured (patterned). A patterned substrate may be formed of any number of features in or on the flow cell surface so long as the features are sized spaced to allow resolution of target analytes at low-micron or sub-micron resolution ranges. Such features may include, e.g., nanowells or planar arrays, which may be disposed in or on a surface of the flow cell in a repeating pattern (e.g., a geometric grid), a nonrepeating pattern, or in a random arrangement. For example, an NOS workflow typically employs patterned flow cells etched with billions of nanowells at fixed locations for clustering clonal populations of discrete nucleic acid fragments in individual nanowells. Flow cells may include single-surface or multi-surface architectures. A multi-surface flow cell may include a first support surface and a second support surface, where each surface supports a pattern of nanowells for clustering clonal populations of discrete nucleic acid fragment. Appropriate structures, constructs, and imaging methods for implementing a multi-surface flow are disclosed in U.S. Pat. No. 8,039,817, which is incorporated as if set forth fully herein.

Fluorescence microscopy is performed using an optical sequencing system that includes a light source (e.g., lasers, light emitting diodes (LEDs)) tuned to wavelengths of light that induce excitation in the fluorescent dyes used for labelling a biological sample; one or more optical instruments, such as cameras, lenses, sensors, to capture signals emitted through induced excitation, and one or more processors for developing composite images from captured signals emitted from labelled biological samples within the optical elements' field of view (tile) in a given sequencing assay, in which each round corresponds to an exposure cycle of the imaging system. In each cycle, the biological samples in the tile are exposed to excitation power. In SBS, the total number of cycles of a sequencing run corresponds to a read length of bases on the template strands of each of the clusters. Example read lengths may be 50, 75, 150, and/or 300 base pairs, which correspond to a respective number of total cycles. However, other read lengths may be similarly implemented. Moreover, the fluorescence chemistry used in SBS may use multiple images (e.g., as many as four images) per cycle to capture fluorescence of each of the base types (e.g., four base types) added in a given round. For example, in four-channel chemistry, bases may be identified using four different fluorescent dyes for each nitrogenous base and four images per sequencing cycle. At the end of the last cycle of an SBS-based sequencing assay, for example, the grouping of clusters from a fully sequenced tile will have cumulative exposure to excitation power equal to four times the total number of cycles. To mitigate risks of photo-damage acquired through the numerous exposure cycles, SBS chemistry has standardized around a two-channel technique that uses two fluorescent dyes and two images to determine all four base calls. Images may be taken using red and green filter bands, where Thymines are labeled with a green fluorophore, cytosines are labeled with a red fluorophore, and adenines are labeled with both red and green fluorophores, and Guanines are permanently dark.

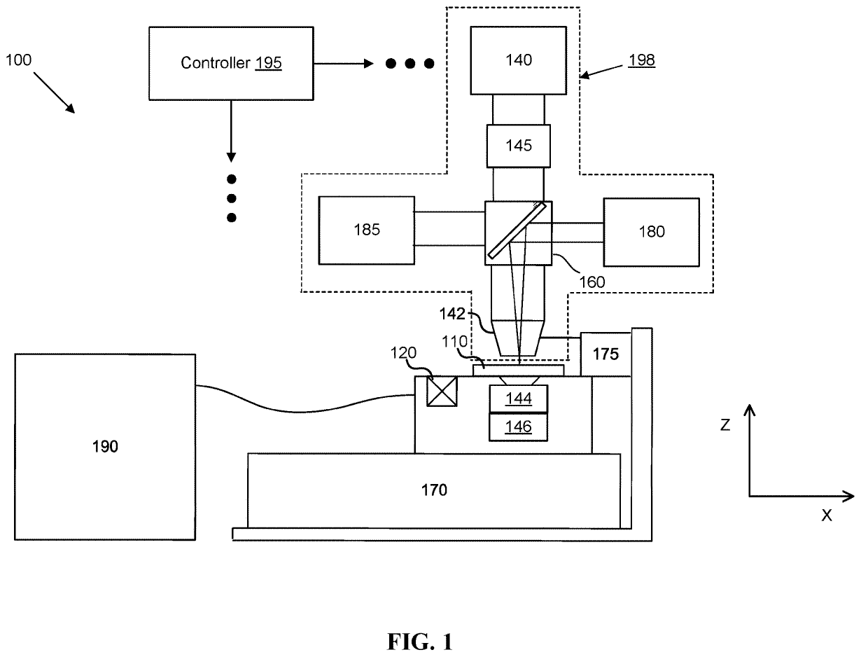

FIG. 1 illustrates a schematic diagram of an example of an imaging system 100 that may be used to perform an analysis on one or more samples of interest. System 100 is configured to perform a large number of parallel reactions within a flow cell 110. Flow cell 110 may include one or more flow channels that receive a solution from system 100 and direct the solution toward reaction sites of flow cell 110.

System 100 includes a system controller 195 that may communicate with the various components, assemblies, and sub-systems of the system 100. The system controller 195 may include one or more components of a computing device for processing and/or communicating information. In various implementations, the system controller 195 may be implemented using hardware, software algorithms (e.g., machine executable instructions), or a combination of the foregoing. For example, in some implementations the system controller 195 may include one or more CPUs, GPUs, or processors with associated memory. As another example, the system controller 195 may comprise hardware or other circuitry to control the operation, such as a computer processor and a non-transitory computer readable medium with machine-readable instructions stored thereon. For example, this circuitry may include one or more of the following: field programmable gate array (FPGA), application specific integrated circuit (ASIC), programmable logic device (PLD), complex programmable logic device (CPLD), a programmable logic array (PLA), programmable array logic (PAL) and other similar processing device or circuitry. The system controller 195 may process information (e.g., using artificial intelligence (AI) and/or non-AI algorithms), as further described herein. The system controller 195 may include a transceiver, transmitter, receiver, and/or other communication circuitry configured to transmit and/or receive information via wired or wireless communications. For example, the system controller 195 may include a processor capable of processing information received from one or more components in the system 100 and/or one or more components of an external system (e.g., external computing system).

An imaging assembly 198 of system 100 includes a light emitting assembly 180 that emits light that reaches reaction sites on flow cell 110. Light emitting assembly 180 may include an incoherent light emitter (e.g., emit light beams output by one or more excitation diodes), or a coherent light emitter such as emitter of light output by one or more lasers or laser diodes. In some implementations, light emitting assembly 180 may include a plurality of different light sources (not shown), each light source emitting light of a different wavelength range. Some versions of light emitting assembly 180 may also include one or more collimating lenses (not shown), a light structuring optical assembly (not shown), a projection lens (not shown) that is operable to adjust a structured beam shape and path, epifluorescence microscopy components, and/or other components. Although system 100 is illustrated as having a single light emitting assembly 180, multiple light emitting assemblies 180 may be included in some other implementations.

In the present example, the light from light emitting assembly 180 is directed by dichroic mirror assembly 160 through an objective lens assembly 142 onto a sample of a flow cell 110, which is positioned on a motion stage 170. In the case of fluorescent microscopy of a sample, a fluorescent element associated with the sample of interest fluoresces in response to the excitation light, and the resultant light is collected by objective lens assembly 142 and is directed to an image sensor of camera system 140 to detect the emitted fluorescence. In some implementations, a tube lens assembly may be positioned between the objective lens assembly 142 and the dichroic mirror assembly 160 or between the dichroic mirror 160 and the image sensor of the camera system 140. A moveable lens element may be translatable along a longitudinal axis of the tube lens assembly to account for focusing on an upper interior surface or lower interior surface of the flow cell 110 and/or spherical aberration introduced by movement of the objective lens assembly 142.

In the present example, a filter switching assembly 145 is interposed between dichroic mirror assembly 160 and camera system 140. Filter switching assembly 145 includes one or more emission filters that may be used to pass through particular ranges of emission wavelengths and block (or reflect) other ranges of emission wavelengths. For example, emission filters may be used to direct different wavelength ranges of emitted light to different image sensors of the camera system 140 of imaging assembly 198. For instance, the emission filters may be implemented as dichroic mirrors that direct emission light of different wavelengths from flow cell 110 to different image sensors of camera system 140. In some variations, a projection lens is interposed between filter switching assembly 145 and camera system 140. Filter switching assembly 145 may be omitted in some versions.

System 100 further includes a fluid delivery assembly 190 that may direct the flow of reagents (e.g., fluorescently labeled nucleotides, buffers, enzymes, cleavage reagents, etc.) to (and through) flow cell 110 and waste valve 120. System 100 of the present example also includes a temperature station actuator 146 and heater/cooler 144 that may optionally regulate the temperature of conditions of the fluids within the flow cell 110. In some implementations, the heater/cooler 144 may be fixed to sample stage 170, upon which the flow cell 110 is placed, and/or may be integrated into sample stage 170.

Flow cell 110 may be removably mounted on sample stage 170, which may provide movement and alignment of flow cell 110 relative to objective lens assembly 142. Sample stage 170 may have one or more actuators to allow sample stage 170 to move in any of three dimensions. For example, actuators may be provided to allow sample stage 170 to move in the x, y, and z directions relative to objective lens assembly 142, tilt relative to objective lens assembly 142, and/or otherwise move relative to objective lens assembly 142. Movement of sample stage 170 may allow one or more sample locations on flow cell 110 to be positioned in optical alignment with objective lens assembly 142. Movement of sample stage 170 relative to objective lens assembly 142 may be achieved by moving sample stage 170 itself, by moving objective lens assembly 142, by moving some other component of imaging assembly 198, by moving some other component of system 100, or any combination of the foregoing. For instance, in some implementations, the sample stage 170 may be actuatable in the x and y directions relative to the objective lens assembly 142 while a focus component 175 or z-stage may move the objective lens assembly 142 along the z direction relative to the sample stage 170.

In some implementations, a focus component 175 may be included to control positioning of one or more elements of objective lens assembly 142 relative to the flow cell 110 in the focus direction (e.g., along the z-axis or z-dimension). Focus component 175 may include one or more actuators physically coupled to the objective lens assembly 142, the optical stage, the sample stage 170, or a combination thereof, to move flow cell 110 on sample stage 170 relative to the objective lens assembly 142 to provide proper focusing for the imaging operation. In the present example, the focus component 175 utilizes a focus tracking module 185 that is configured to detect a displacement of the objective lens assembly 142 relative to a portion of the flow cell 110 and output data indicative of an in-focus position to the focus component 175 or a component thereof or operable to control the focus component 175, such as controller 195, to move the objective lens assembly 142 to position the corresponding portion of the flow cell 110 in focus of the objective lens assembly 142.

In some implementations, an actuator of focus component 175 or for sample stage 170 may be physically coupled to objective lens assembly 142, the optical stage, sample stage 170, or a combination thereof, such as, for example, by mechanical, magnetic, fluidic, or other attachment or contact directly or indirectly to or with the stage or a component thereof. The actuator of focus component 175 may be configured to move objective lens assembly 142 in the z-direction while maintaining sample stage 170 in the same plane (e.g., maintaining a level or horizontal attitude, perpendicular to the optical axis). In some implementations, sample stage 170 includes an x direction actuator and a y direction actuator to form an x-y stage. Sample stage 170 may also be configured to include one or more tip or tilt actuators to tip or tilt sample stage 170 and/or a portion thereof, to account for any slope in its surfaces.

In some embodiments, the optical sequencing systems may include a dynamic auto focusing operation as disclosed in U.S. Pat. No. 9,404,737, which is incorporated herein by reference. A dynamic auto focusing operation may analyze a focus setting at each displacement of the flow cell during scanning/step-and-shoot and generate a focus score based on at least one of contrast, spot size, a signal-to-noise ratio, and a mean-square-error between pixel values for the at least one image being analyzed. Based on a focus score, dynamic auto focusing operation may affect a shift in the focal setting for a next scanning/step-and-shoot step, which may include modulating a z-position of the focus lens with respect to the collection area of the sample.

Camera system 140 may include one or more image sensors to monitor and track the imaging (e.g., sequencing) of flow cell 110. Camera system 140 may be implemented, for example, as a CCD or CMOS image sensor camera, but other image sensor technologies (e.g., active pixel sensor) may be used. By way of further example only, camera system 140 may include a multi-sensor time delay integration (TDI) camera, a single-sensor camera, a camera with one or more two-dimensional image sensors, and/or other kinds of camera technologies. While camera system 140 and associated optical components are shown as being positioned above flow cell 110 in FIG. 1, one or more image sensors or other camera components may be incorporated into system 100 in numerous other ways as will be apparent to those skilled in the art in view of the teachings herein. For instance, one or more image sensors may be positioned under flow cell 110, such as within the sample stage 170 or below the sample stage 170; or may even be integrated into flow cell 110.

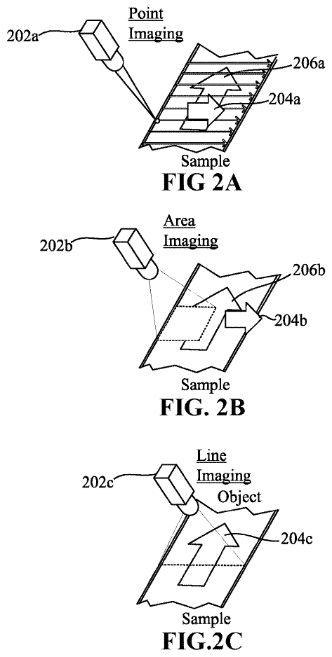

FIGS. 2A-C collectively illustrate various sequencing image collection techniques for a sample. Point, area, and line scan imaging techniques are illustrated. Image data is collected by an imager (202a-c) for a collection area (such as corresponding to a tile of a flow cell). One or more examples of the imager may include one or more portions of the imaging assembly 198 shown in FIG. 1. Point imaging collects point-images as relatively smaller collections of one or more pixels, collecting image data for larger areas by progressing, as illustrated, from left to right (204a), then up (206a), then again left to right, and so forth, via relative movement of the imager 202a and the collection area, such as in discrete point-and-shoot operation. Area imaging collects area-images as relatively larger collections of pixels, such as in a rectangular (e.g., square) shape. Area image collection progresses similarly to that of point imaging, by progressing, as illustrated, from left to right (204b), then up (206b), then again left to right, and so forth, via relative movement of the imager 202b and the collection area, such as in discrete point-and-shoot operation.

Line imaging collects line-images as collections of pixels corresponding to a rectangular region of a relatively high aspect ratio, such as a single pixel high and several pixels wide corresponding to the collection area width. Line image collection progresses a line at a time in a direction orthogonal to the line (204c), via relative movement of the imager 202e and the collection area. Some implementations of line imaging correspond to discrete point-and-shoot operation. Some implementations of line imaging correspond to continuous scanning operation.

Some implementations of continuous scanning operation are performed using Time Delay Integration (TDI). A TDI operation performs sequential detection of different portions of a sample by different subsets of elements of a detector array, wherein transfer of charge between the subsets of elements proceeds at a rate synchronized with and in the same direction as the apparent motion of the sample being imaged. For example, TDI can be carried out by scanning a sample such that a frame transfer device produces a continuous video image of the sample by means of a stack of linear arrays aligned with and synchronized to the apparent movement of the sample, whereby as the image moves from one line to the next, the stored charge moves along with it. Accumulation of charge can integrate during the entire time required for the row of charge to move from one end of the detector to a serial register or storage area of the device (in the case of a frame transfer charge-coupled device (CCD)).

The optical sequencing systems may be limited by the optical resolution of the data capable of being detected by the optical sequencing systems. In microscopy, optical resolution is the shortest distance between two separate points in a microscope's field of view that can still be distinguished as distinct entities. For example, the optical resolution of such objects may be expressed as a function of a wavelength (λ) of light in the optical sequencing system, in which shorter wavelengths yield higher resolution, and an objective, or optical element (e.g., lens or lenses) used to gather the light from the target objects, which may be measured by a numerical aperture (NA). NA of an objective lens is given by the formula n sine θ. where n is the index of refraction of the medium in which the lens is working (nₐᵢᵣ≈1), and θ is the half-angle of the maximum cone of light that can enter or exit the lens.

The resolving power (r) of a system is the minimum distance between two points that may be resolved by the microscope, i.e., the Rayleigh Limit, given by the formula:

r=0.61λ/NA

Accordingly, an optical sequencing system using an objective lens having a relatively high NA can resolve more closely adjacent point sources compared to a system characterized by a relatively lower NA. NA thus determines the resolving power of an objective lens of an optical sequencing system. The higher the numerical aperture of the total system, the better the resolution, Higher quality detection lenses and other detection optical elements thus may be used to improve the optical resolution of the optical sequencing systems.

Because resolution of an optical sequencing system may be defined as the smallest distance between two points on a specimen that can still be distinguished as two separate entities, i.e., the Rayleigh limit, a low-resolution microscope as contemplated herein thus may be characterized as having a Rayleigh limit (r_{low}) higher than the Rayleigh limit of a high-resolution microscope (r_{high}). Therefore, if we define d as the distance between two adjacent point sources, there is a range of values of d in which a high-resolution microscope can distinguish each of the two adjacent point sources, but the low-resolution microscope cannot. This relationship is satisfied by: r_{high}<d<r_{low}.

Structured illumination microscopy (SIM) may be implemented by an optical sequencing system to take multiple images of a target object, with varying angles and phase displacements of structured illumination to generate a computational transform (Fourier transform) that is then used to reconstruct closely spaced, otherwise unresolvably high spatial frequency features, into lower frequency signals that may be sensed by an optical system without violating the Abbe diffraction limit. In that manner, captured raw images (e.g., six or nine images) may be assembled into a single image having an extended spatial frequency bandwidth, which may be transformed into real space to generate an image having a higher resolution than one captured by other imaging systems.

SIM is a technique by which spatially structured (e.g., patterned) light, usually sinusoidal, may be used to image a sample to increase the lateral resolution of the microscope by a factor of two or more. SIM holds the potential to resolve densely packed samples, from flow cells with fluorescent signals from millions of sample points, thereby reducing reagents needed for processing and increasing image processing throughput.

Structured illumination may produce images that have several times as many resolved illumination sources as with normal illumination. Information is not simply created. Instead, multiple images with varying angles and phase displacements of structured illumination are used to transform closely spaced, otherwise unresolvably high spatial frequency features, into lower frequency signals that may be sensed by an optical sequencing system without violating the Abbe diffraction limit. Applying SIM reconstruction, information from multiple images is transformed from the spatial domain into the Fourier domain, combined and processed, then reconstructed into an enhanced image.

In SIM, a grating is used, or an interference pattern is generated, between the illumination source and the sample, to generate an illumination pattern, such as a pattern that varies in intensity according to a sine or cosine function. In the SIM context, “grating” is sometimes used to refer to the projected structured illumination pattern, in addition to the surface that produces the structured illumination pattern. The structured illumination pattern alternatively may be generated as an interference pattern between parts of a split coherent beam.

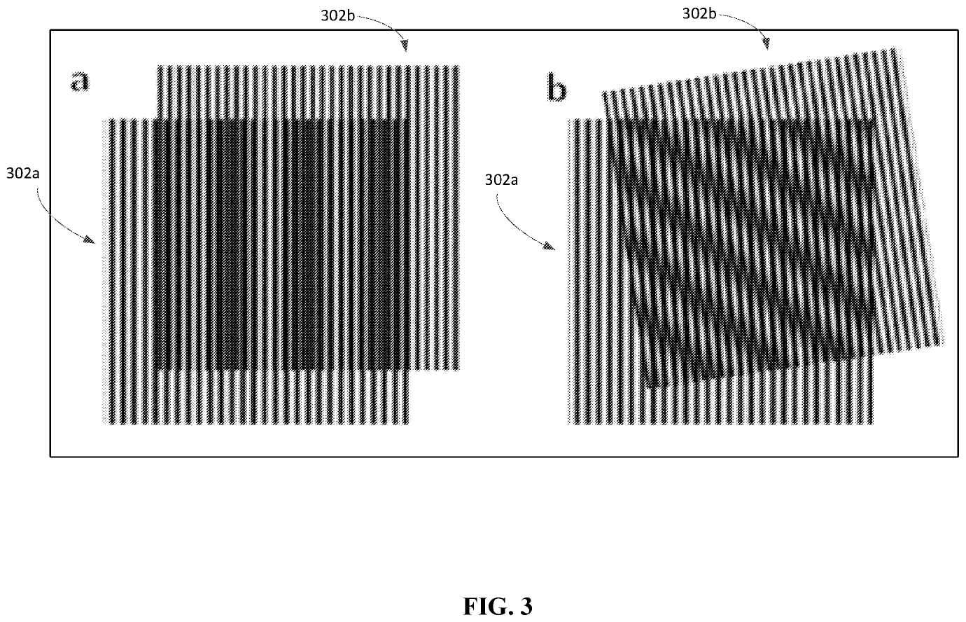

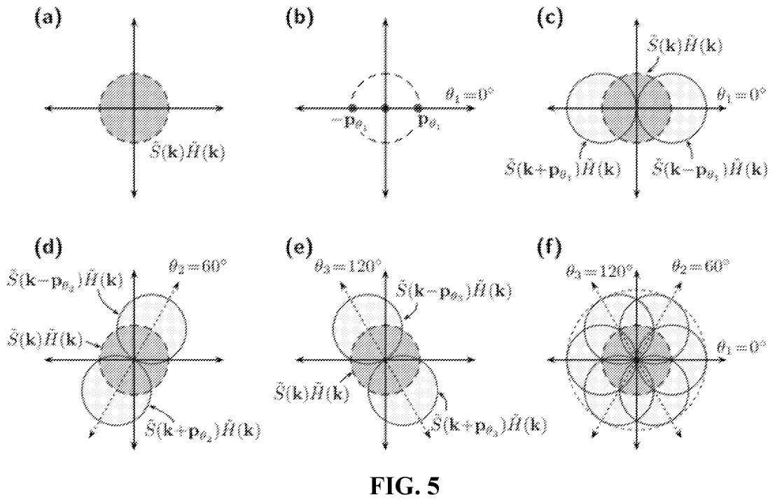

Projection of structured illumination onto a sample plane, for example in FIG. 5, mixes the illumination pattern with fluorescent (or reflective) sources in a sample to induce a new signal, sometimes called a Moiré fringe or aliasing. The new signal shifts high-spatial frequency information to a lower spatial frequency that may be captured without violating the Abbe diffraction limit. After capturing images of a sample illuminated with a 1D intensity modulation pattern, as shown in FIG. 3, a linear system of equations referred to as the Fornier Transform is solved and used to extract from multiple images of the Moiré fringe or aliasing, parts of the new signal that contains information shifted from the higher to the lower spatial frequency. To solve the linear equations, three or more images are captured with the structured illumination pattern shifted or displaced in steps. Often, images of varying phases (3 to 7 phases) per angle (with one to five angles) are captured for analysis and then separated by bands for Fourier domain shifting and recombination. Increasing the number of images may improve the quality of reconstructed images by boosting the signal-to-noise ratio. However, it may also increase computation time. The Fourier representation of the band separated images is shifted and summed to produce a reconstructed sum. Eventually, an inverse Fast Fourier Transform reconstructs a new high-resolution image from the reconstructed sum.

Applying the multiple-image and shifting approach enhances image information in a specific direction along which a 1D structured illumination pattern is shifted, so the structured illumination or grating pattern is rotated, and the shifting procedure repeated. Rotations such as 45, 60, 90 or 120 degrees of a 1D pattern may be applied to produce six or nine images in sets of three steps. Environmental factors such as damage to molecules on the surface of flow cells due to blue and green colored lasers, tilts of tiles on the surface of flow cells etc., may cause distortions in phase bias estimations for image subtiles or subwindows of the full field of view (FOV) image. They also may cause differences among tiles across a substrate. More frequent estimation of SIM image reconstruction parameters may be performed to compensate for these environmental factors. For example, the phase biases of subtiles may be re-estimated for every tile, every cycle of reconstruction to minimize these errors. Angle and spacing parameters may not change as frequently as phase bias and therefore, increasing their estimation frequency may introduce additional compute that is not necessary. However, angle and spacing parameters may be computed more frequently.

FIG. 3 shows Moiré fringe (or Moiré pattern) formation by using a grating with 1D modulation. The surface containing the sample is illuminated by a structured pattern of light intensity, typically sinusoidal, to effect Moiré fringe formation. FIG. 3 shows two sinusoidal patterns 302a, 302b when their frequency vectors, in frequency or reciprocal space, are (a) parallel and (b) non-parallel. FIG. 3 is a typical illustration of shifting high-frequency spatial information to lower frequency that may be optically detected. The new signal is referred to as Moiré fringe or aliasing. In some instances, during imaging of the sample, three images of fringe patterns of the sample are acquired at various pattern phases (e.g., 0°, 120°, and 240°), so that each location on the sample is exposed to a range of illumination intensities, with the procedure repeated by rotating the pattern orientation about the optical axis to 2 (e.g., 45°, 135°) or 3 (e.g., 0°, 60° and 120°) separate angles. The captured images (e.g., six or nine images) may be assembled into a single image having an extended spatial frequency bandwidth, which may be retransformed into real space to generate an image having a higher resolution than one captured by a conventional microscope.

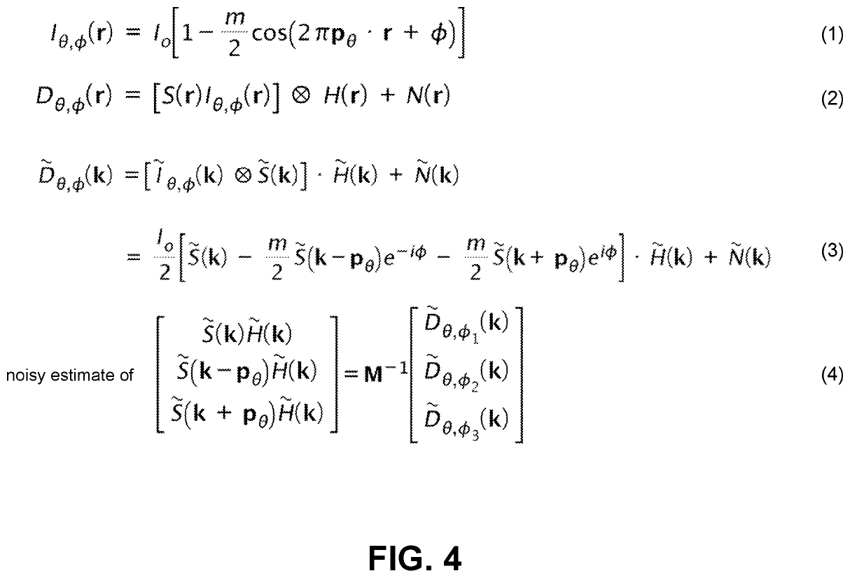

Fourier Transform linear equations (1)-(4) are shown in FIG. 4 and reproduced below. In equations (1) and (2), S(r) represent fluorophore density distribution within specimen and I_{θ,φ}(r) is the illuminating sinusoidal intensity pattern, where equation (1) is given as

$${I}_{θ , ϕ} ( r ) = {I}_{o} [ 1 - \frac{m}{2} cos ( 2 π {p}_{θ} \cdot r + ϕ ) ] \qquad ( 1 )$$

where r≡(x, y) is the (two dimensional) spatial position vector, Iₒ is peak illumination intensity, p θ=(p·cos θ, p·sin θ) is (sinusoidal) illumination frequency vector in reciprocal space, φ is phase of illumination pattern and m is modulation factor, and script θ indicates the orientation of sinusoidal illumination pattern.

The fluorescence emission distribution from specimen is S(r)·Iθ,φ(r), and the observed emission distribution through the optical system is thus given as equation (2)

$${D}_{θ , ϕ} ( r ) = [ S ( r ) {I}_{θ , ϕ} ( r ) ] ⊗ H ( r ) + N ( r ) \qquad ( 2 )$$

where H(r) is optical system's PSF, ⊗ is convolution operator and N(r) is additive Gaussian (white) noise.

Fourier transform of observed image is then given by

$${\tilde{D}}_{θ , ϕ} ( k ) = [ {\tilde{I}}_{θ , ϕ} ( k ) ⊗ \tilde{S} ( k ) ] \cdot \tilde{H} ( k ) + \tilde{N} ( k ) = \frac{{I}_{o}}{2} [ \tilde{S} ( k ) - \frac{m}{2} \tilde{S} ( k - {p}_{θ} ) {e}^{- iϕ} - \frac{m}{2} \tilde{S} ( k + {p}_{θ} ) {e}^{iϕ} ] \cdot \tilde{H} ( k ) + \tilde{N} ( k ) \qquad ( 3 )$$

where H^{~}(k) is system Optical Transfer Function (OTF) and D^{~}θ,φ(k) is a linear combination of frequency content within three circular regions of specimen S^{~}(k); centered at origin −pθ and pθ.

FIG. 5 is a graphical depiction of the observable and computationally obtained frequency content of a target under structured illumination from nine raw images taken at three illumination phases Dθ,φ1(r), Dθ,φ2(r) and Dθ,φ3 (r) at angles φ1=0°, φ2=60° and φ3=120°. As shown graph (a) of FIG. 5, the observable frequency content of raw image data in reciprocal space, represented by the pink circular region, is limited by optical system OTF, H^{~}(k). FIG. 5 illustrates a graph (b) that graphs the frequency content of sinusoidally varying intensity pattern (vertical stripes, θ1=0°) relative to optical system OTF and (c) reflects the observed frequency content of structured illuminated specimen of D^{~}θ,φ(k) as a linear combination of frequency content within three circular regions, as determined by equation (3). The frequency content within crescent shaped yellow regions become observable due to Moire' effect and may be analytically computed using equation (4) in FIG. 4.

$$noisy estimate of [ \begin{matrix}\tilde{S} ( k ) \tilde{H} ( k ) \\ \tilde{S} ( k - {p}_{θ} ) \tilde{H} ( k ) \\ \tilde{S} ( k + {p}_{θ} ) \tilde{H} ( k )\end{matrix} ] = {M}^{- 1} [ \begin{matrix}{\tilde{D}}_{θ , {ϕ}_{1}} ( k ) \\ {\tilde{D}}_{θ , {ϕ}_{2}} ( k ) \\ {\tilde{D}}_{θ , {ϕ}_{3}} ( k )\end{matrix} ] \qquad ( 4 )$$

where ungraded approximations of S^{~}(k), S^{~}(k−pθ) and S^{~}(k+pθ) are obtained by Wiener filtering of their corresponding noisy estimates obtained by above equation, and the centers of frequency components S^{~}(k−pθ) and S^{~}(k+pθ) are sub-pixelly shifted to their correct locations, +pθ and −pθ respectively, in the reciprocal space, By changing the angular orientation θ of the illuminating sinusoidal pattern (typically, three different angular orientations—at θ1=0°, θ2=60°, and θ3=120°) and by repeating the linear computations (1)-(4), nearly all frequency content of imaging data lying within a circular region of radius twice of that governed by the OTF of optical system may be computed, as reflected in frequency components of full transform of graph (f) show in FIG. 5. The separately obtained frequency contents are eventually merged as D^{~}SIM(k) using generalized Wiener-Filter and an inverse Fourier Transform of D^{~}SIM(k) is then calculated to obtain reconstructed SIM image DSIM(r), in accordance with algorithms described, e.g., in Amit Lal, Chunyan Shan, and Peng Xi, Structured Illumination Microscopy Image Reconstruction Algorithm, arXiv: 1602.06904v1 ((http://) arxiv.org/abs/1602.06904v1), which is incorporated by reference as if fully set forth herein.

In some implementations of SIM systems, a linearly polarized light beam may be directed through an optical beam splitter that splits the beam into two or more separate orders that may be combined and projected on the imaged sample as an interference fringe pattern with a sinusoidal intensity variation. Diffraction gratings are examples of beam splitters that may generate beams with a high degree of coherence and stable propagation angles. When two such beams are combined, the interference between them may create a uniform, regularly-repeating fringe pattern where the spacing is determined by factors including the angle between the interfering beams. Though FIG. 3 shows an example of structured illumination using 1D structured illumination patterns, 2D structured illumination may similarly be performed.

When using ID structured illumination, the illumination peak angle may be selected such that images are taken along a line connecting diagonally opposed corners of the rectangle. For example, two sets of three images (a total of six images) may be taken at +45 degree and −45-degree angles. As the distance along the diagonal is more than the distance between any two sides of the rectangle, we are able to achieve a higher resolution image. Nanowells may be arranged in other geometric arrangements such as a hexagon. Three or more images may then be taken along each of three diagonals of the hexagon, resulting, for instance, in nine or fifteen images.

During capture and/or subsequent assembly or reconstruction of images into a single image having an extended spatial frequency bandwidth, the following structured illumination parameters may be considered: the orientation or angle of the fringe pattern also referred to as illumination peak angle relative to the illuminated sample, the spacing between adjacent fringes referred to as illumination peak spacing (i.e., frequency of fringe pattern), and phase displacement of the structured illumination pattern. In an ideal imaging system, not subject to factors such as mechanical instability and thermal variations, each of these parameters would not drift or otherwise change over time, and the precise SIM frequency, phase, and orientation parameters associated with a given image sample would be known. However, due to factors such as mechanical instability of an excitation beam path and/or thermal expansion/contraction of an imaged sample, these parameters may drift or otherwise change over time.

As such, a SIM imaging system may estimate structured illumination parameters to account for their variance over time. As many SIM imaging systems do not perform SIM image processing in real-time (e.g., they process captured images offline), such SIM systems may spend a considerable amount of computational time to process a SIM image to estimate structured illumination parameters for that image.

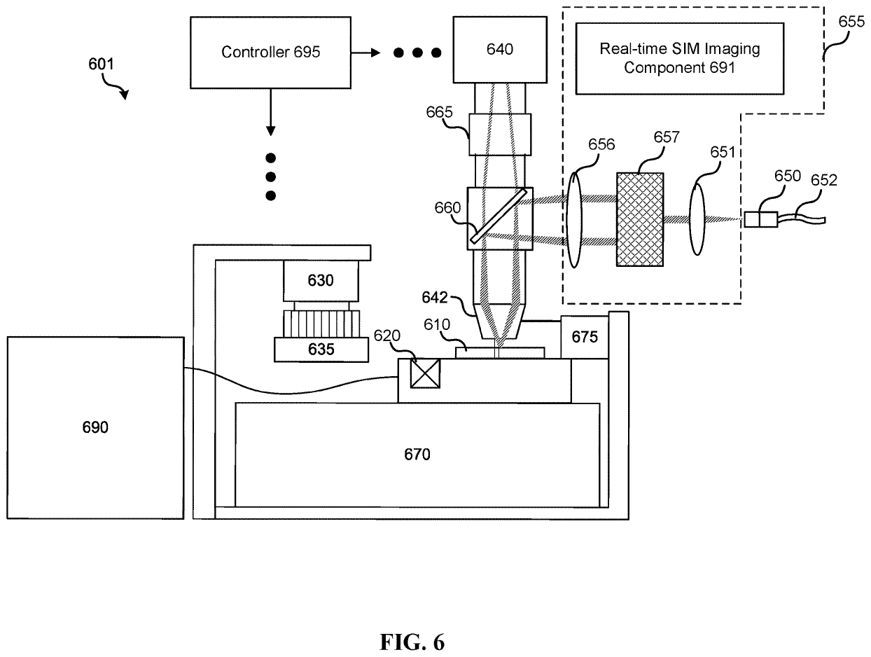

FIG. 6 is a diagram of an example SIM imaging system 601 that may be implemented as described herein. For example, system 601 may be a structured illumination fluorescence microscopy system that utilizes structured illumination to image a biological sample.

In the example of FIG. 6, a light source 650 may be configured to output a light beam that is collimated by collimation lens 651. The collimated light is structured (patterned) by light structuring optical assembly 657 and directed by dichroic mirror 660 through objective lens 642 onto a sample of a sample container 610, which is positioned on a motion stage 670. In the case of a fluorescent sample, the sample fluoresces in response to the structured excitation light, and the resultant light is collected by objective lens 642 and directed to an image sensor of a sensor system (e.g., camera system 640) to detect fluorescence.

Light structuring optical assembly 657 includes one or more optical diffraction gratings or other beam splitting elements (e.g., a beam splitter cube or plate) to generate a pattern of light (e.g., fringes, typically sinusoidal) that is projected onto samples of a sample container 610. The diffraction gratings may be one-dimensional or two-dimensional transmissive or reflective gratings. The diffraction gratings may be sinusoidal amplitude gratings or sinusoidal phase gratings.

In some implementations, the diffraction grating(s) s may not utilize a rotation stage to change an orientation of a structured illumination pattern. In other implementations, the diffraction grating(s) may be mounted on a rotation stage. In some implementations, the diffraction gratings may be fixed during operation of the imaging system (e.g., not require rotational or linear motion). For example, in a particular implementation, further described below, the diffraction gratings may include two fixed one-dimensional transmissive diffraction gratings oriented perpendicular to each other (e.g., a horizontal diffraction grating and vertical diffraction grating).

As illustrated in the example of FIG. 6, light structuring optical assembly 657 may output the first orders of the diffracted light beams (e.g., m=±1 orders) while blocking or minimizing other orders, including the zeroth orders. However, in alternative implementations, additional orders of light may be projected onto the sample.

During each imaging cycle, imaging system 601 may utilize light structuring optical assembly 657 to acquire a plurality of images at various phases, with the fringe pattern displaced laterally in the modulation direction (e.g., in the x-y plane and perpendicular to the fringes), with this procedure repeated one or more times by rotating the pattern orientation about the optical axis (e.g., with respect to the x-y plane of the sample). The captured images may then be computationally reconstructed to generate a higher resolution image (e.g., an image having about twice the lateral spatial resolution of individual raw images).

In system 601, light emitter 650 may be an incoherent light emitter (e.g., emit light beams output by one or more excitation diodes), or a coherent light emitter such as emitter of light output by one or more lasers or laser diodes. As illustrated in the example of system 601, light emitter 650 includes an optical fiber 652 for guiding an optical beam to be output. However, other configurations of a light emitter 650 may be used. In implementations utilizing structured illumination in a multi-channel imaging system (e.g., a multi-channel fluorescence microscope utilizing multiple wavelengths of light), optical fiber 652 may optically couple to a plurality of different light sources (not shown), each light source emitting light of a different wavelength. Although system 601 is illustrated as having a single light emitter 650, in some implementations multiple light emitters 650 may be included. For example, multiple light emitters may be included in the case of a structured illumination imaging system that utilizes multiple arms, further discussed below.

In some implementations, system 601 may include a tube lens 656 that may include a lens element to articulate along the z-axis to adjust the structured beam shape and path. For example, a component of the tube lens may be articulated to account for a range of sample thicknesses (e.g., different cover glass thickness) of the sample in container 610.

In the example of system 601, fluid delivery module or device 690 may direct the flow of reagents (e.g., fluorescently labeled nucleotides, buffers, enzymes, cleavage reagents, and/or other reagents) to (and through) sample container 610 and waste valve 620. Sample container 610 may include one or more substrates upon which the samples are provided. For example, in the case of a system to analyze a large number of different nucleic acid sequences, sample container 610 may include one or more substrates on which nucleic acids to be sequenced are bound, attached, or associated. The substrate may include any inert substrate or matrix to which nucleic acids may be attached, such as for example glass surfaces, plastic surfaces, latex, dextran, polystyrene surfaces, polypropylene surfaces, polyacrylamide gels, gold surfaces, and silicon wafers. In some applications, the substrate is within a channel or other area at a plurality of locations formed in a matrix or array across the sample container 610. System 100 may also include a temperature station actuator 630 and heater/cooler 635 that may optionally regulate the temperature of conditions of the fluids within the sample container 610.

In particular implementations, the sample container 610 may be implemented as a patterned flow cell including a translucent cover plate, a substrate, and a liquid contained therebetween, and a biological sample may be located at an inside surface of the translucent cover plate or an inside surface of the substrate. The flow cell may include a large number (e.g., thousands, millions, or billions) of wells (also referred to as nanowells) or regions that are patterned into a defined array (e.g., a hexagonal array, rectangular array, and/or other arrays) into the substrate. Each region may form a cluster (e.g., a monoclonal cluster) of a biological sample such as DNA, RNA, or another genomic material which may be sequenced, for example, using sequencing by synthesis. The flow cell may be further divided into a number of spaced apart lanes (e.g., eight lanes), each lane including a hexagonal array of clusters.

Sample container 610 may be mounted on a sample stage 670 to provide movement and alignment of the sample container 610 relative to the objective lens 642. The sample stage may have one or more actuators to allow it to move in any of three dimensions. For example, in terms of the Cartesian coordinate system, actuators may be provided to allow the stage to move in the X, Y and Z directions relative to the objective lens. This may allow one or more sample locations on sample container 610 to be positioned in optical alignment with objective lens 642. Movement of sample stage 670 relative to objective lens 642 may be achieved by moving the sample stage itself, the objective lens, some other component of the imaging system, or any combination of the foregoing. Further implementations may also include moving the entire imaging system over a stationary sample. Alternatively, sample container 610 may be fixed during imaging.

In some implementations, a focus (z-axis) component 675 may be included to control positioning of the optical components relative to the sample container 610 in the focus direction (which may be referred to as the z axis, or z direction). Focus component 675 may include one or more actuators physically coupled to the optical stage or the sample stage, or both, to move sample container 610 on sample stage 670 relative to the optical components (e.g., the objective lens 642) to provide proper focusing for the imaging operation. For example, the actuator may be physically coupled to the respective stage such as, for example, by mechanical, magnetic, fluidic or other attachment or contact directly or indirectly to or with the stage. The one or more actuators may be configured to move the stage in the z-direction while maintaining the sample stage in the same plane (e.g., maintaining a level or horizontal attitude, perpendicular to the optical axis). The one or more actuators may also be configured to tilt the stage. This may be done, for example, so that sample container 610 may be leveled dynamically to account for any slope in its surfaces.

The structured light emanating from a test sample at a sample location being imaged may be directed through dichroic mirror 660 to one or more detectors of camera system 640. In some implementations, a filter switching assembly 665 with one or more emission filters may be included, where the one or more emission filters may be used to pass through particular emission wavelengths and block (or reflect) other emission wavelengths. For example, the one or more emission filters may be used to switch between different channels of the imaging system. In a particular implementation, the emission filters may be implemented as dichroic mirrors that direct emission light of different wavelengths to different image sensors of an imaging system, such as camera system 640.

Camera system 640 may include one or more image sensors to monitor and track the imaging (e.g., sequencing) of sample container 610. Camera system 640 may be implemented, for example, as a charge-coupled device (CCD) image sensor camera, but other image sensor technologies (e.g., active pixel sensor) may be used.

Output data (e.g., images) from camera system 640 may be communicated to a real-time SIM imaging component 691 that may be implemented as a software application that may reconstruct the images captured during each imaging cycle to create an image having a higher spatial resolution using an algorithm incorporating the Fourier Transform and inverse Fourier Transform equations as set forth herein, e.g., FIG. 5, and as further described in Lal et al. The reconstructed images may take into account changes in structure illumination parameters that are predicted over time. In addition, SIM imaging component 691 may be used to track predicted SIM parameters and/or make predictions of SIM parameters given prior estimated and/or predicted SIM parameters.

A system controller 695 may be provided that may communicate with the various components, assemblies, and sub-systems of the system 601. The system controller 695 may include one or more components of a computing device for processing and/or communicating information. In various implementations, the system controller 695 may be implemented using hardware, software algorithms (e.g., machine executable instructions), or a combination of the foregoing. For example, in some implementations the system controller 695 may include one or more CPUs, GPUs, or processors with associated memory. As another example, the system controller 695 may comprise hardware or other circuitry to control the operation, such as a computer processor and a non-transitory computer readable medium with machine-readable instructions stored thereon. For example, this circuitry may include one or more of the following: field programmable gate array (FPGA), application specific integrated circuit (ASIC), programmable logic device (PLD), complex programmable logic device (CPLD), a programmable logic array (PLA), programmable array logic (PAL) and other similar processing device or circuitry. The system controller 695 may process information (e.g., using artificial intelligence (AI) and/or other algorithms), as further described herein. The system controller 695 may include a transceiver, transmitter, receiver, and/or other communication circuitry configured to transmit and/or receive information via wired or wireless communications. For example, the system controller 695 may include a processor capable of processing information received from one or more components in the system 601 and/or one or more components of an external system (e.g., external computing system).

The system controller 695 may be provided to control the operation of structured illumination imaging system 601, including synchronizing the various optical components of system 601. The controller may be implemented to control aspects of system operation such as, for example, configuration of light structuring optical assembly 657 (e.g., selection and/or linear translation of diffraction gratings), movement of tube lens 656, focusing, stage movement, and imaging operations. The controller 695 may also be implemented to control hardware elements of the system 601 to correct for changes in structured illumination parameters over time. For example, the controller 695 may be configured to transmit control signals to motors or other devices controlling a configuration of light structuring optical assembly 657, motion stage 670, or some other element of system 601 to correct or compensate for changes in structured illumination phase, frequency, and/or orientation over time. In implementations, these signals may be transmitted in accordance with structured illumination parameters predicted using SIM imaging component 691. In some implementations, controller 695 may include a memory for storing predicted and or estimated structured illumination parameters corresponding to different times and/or sample positions.

In various implementations, the controller 695 may be implemented using hardware, software algorithms (e.g., machine executable instructions), or a combination of the foregoing. For example, in some implementations the controller may include one or more CPUs, GPUs, or processors with associated memory. As another example, the controller 695 may comprise hardware or other circuitry to control the operation, such as a computer processor and a non-transitory computer readable medium with machine-readable instructions stored thereon. For example, this circuitry may include one or more of the following: field programmable gate array (FPGA), application specific integrated circuit (ASIC), programmable logic device (PLD), complex programmable logic device (CPLD), a programmable logic array (PLA), programmable array logic (PAL) and other similar processing device or circuitry. As yet another example, the controller 695 may comprise a combination of this circuitry with one or more processors. For example, the controller 695 may include a transceiver, transmitter, receiver, and/or other communication circuitry configured to transmit and/or receive information via wired or wireless communications.

One or more portions of the SIM imaging system 601 may be modular, replaceable, and/or removable. For example, the SIM imaging system 601 may include a SIM imaging subsystem 655 that may include one or more modular, replaceable, and/or removable components. The SIM imaging subsystem 655 may include hardware and/or software components. The SIM imaging subsystem 655 may include SIM imaging component 691, collimation lens 651, light structuring optical assembly 657, and/or tube lens 656. Though these components are provided as examples of the SIM imaging subsystem 655 that may be modular, replaceable, and/or removable, additional or fewer portions of the SIM imaging system 601 may be included in the SIM imaging subsystem 655 for being modular, replaceable, and/or removable. In one example, one or more portions of the SIM imaging subsystem 655 may be removed such that the SIM functionality of the imaging system 610 is removed. If the SIM functionality is removed and/or replaced, the imaging system 610 may operate similarly to other non-SIM imaging systems as described herein, such as other imaging systems described with regard to the imaging system 100 shown in FIG. 1.

The modular, replaceable, and/or removable SIM imaging subsystem 655 may allow the imaging system 601 to operate as a SIM imaging system for training the AI models (e.g., during factory training), as described herein, and then the SIM imaging subsystem 655 may be removed and/or replaced for the imaging system 601 to operate without the SIM functionality in production or in other implementations. This would allow the light source 650 to be directed through the objective lens 642 directly (e.g., without passing through the light structuring optical assembly 657 and/or collimation lens 651, and/or without processing by the SIM imaging component 691). Similarly, the SIM imaging subsystem 655 may be used for certain sequencing runs or cycles and be removed and/or replaced for other cycles or sequencing runs.

The AI model or algorithm that is trained using the SIM imaging subsystem 655 may be stored and exported to another imaging system that does not implement a SIM imaging subsystem 655. For example, the SIM imaging subsystem 655 may be used to train an AI model or algorithm, as described herein, to generate a high-resolution image from a low resolution image that is generated from lower-cost and/or lower-quality imaging systems (e.g. hardware and/or software). The SIM imaging subsystem 655 may be implemented in the SIM imaging system 601 to recalibrate the AI model or algorithm. The SIM imaging subsystem 655 may be implemented in the SIM imaging system 601 to train and/or update the AI model or algorithm. The training may be implemented using a low-resolution image that is similar to the resolution of the image that is input into the imaging system 601 during production after the SIM imaging subsystem 655 is removed and/or replaced.

Photon budget requirements for sequencing methodologies on Next Generation Sequencing (NGS) platforms, particularly with SBS-based processes, are relatively high. In one example, NGS workflow involves loading, e.g., a DNA library onto a flow cell and hybridizing individual adapter-ligated DNA fragments to adapter-specific complimentary oligonucleotides covalently bound to a flow cell surface; clustering the individual fragments into thousands of identical DNA template strands (or amplicons) through amplification (e.g., bridge or exclusion amplification); and, finally, sequencing, in which copy strands are simultaneously synthesized and sequenced on the DNA templates using a reversible terminator-based process that detects signals emitted from fluorophore tagged single bases as they are added round by round to the copy strands. Because the multiple template strands of each cluster have the same sequence, base pairs incorporated into the corresponding copy strands in each round will be the same, and thus the signal generated from each round will be enhanced proportional to the number of copies of the template strand in the cluster.

The fluorescence microscopy implemented in NGS is performed using an optical sequencing system that includes a light source (e.g., lasers, light emitting diodes (LEDs)) tuned to wavelengths of light that induce excitation in the fluorescing labels (fluorophores); one or more optical instruments, such as cameras, lenses, sensors, detect and image signals emitted through induced excitation, and one or more processors for developing composite images from signals detected and imaged from a plurality of clusters within the optical elements' field of view (tile) in a given round, in which each round corresponds to an operation cycle of the imaging system. In each cycle, the plurality of clusters is exposed to excitation power. The total number of cycles corresponds to a read length of bases on the template strands of each of the clusters. Example read lengths may be 50, 75, 150, and 300 base pairs, which correspond to a respective number of total cycles. Moreover, the fluorescence chemistry of NOS requires as many as four images per cycle to capture fluorescence of each of the four base types added in a given round. For example, four channel chemistry uses four different fluorescent labels, one for each base, where four images per cycle are necessary to capture fluorescence of the unique labels for each base. One example SBS-based technology involves two-channel chemistry that uses only two fluorescent labels and two images to determine all four base calls. Images are taken using blue and green filter bands, where Thymines are labeled with a green fluorophore, cytosines are labeled with a blue fluorophore, adenines are labeled with both blue and green fluorophores, and Guanines are permanently dark. Other fluorophores may be used, such as other fluorophores in the visible and non-visible spectrum. These exposure requirements apply whether the sequencing ran is conducted in the context of production or training, as described herein.

Samples are susceptible to photodamage and/or photobleaching from repeated exposure to the high-intensity light required to excite fluorophores. Photodamage to the target nucleic acid materials may arise due to generation of chemically reactive species such as free radicals and specifically singlet and triplet forms of oxygen, which can interact with nucleic acid molecules to cause depurination/depyrimidination, hydrolytic deamination and base conversion. Acquired photodamage results in image artifacts and aberrations, and the quality of the data of the signal of interest declines according to a logarithmic decay function with cumulative exposure to excitation over the course of a sequencing run. Photobleaching of the fluorescent labels damage the fluorophore such that the fluorophore has reduced fluorescence (i.e., dimming) or may cease to fluorescence.

As described herein, SIM and other super-resolution optical sequencing systems improve optical resolution, which can be a limiting factor in how dense flow cells and other sample containers may be imaged. However, SIM and other super-resolution image collection and reconstruction processes may require up to a six-to nine-fold increase in photon budget per target corresponding to the number of required image exposures and sophisticated reconstruction algorithms to transform the multiple diffraction-limited images into a single, high-resolution image. Because SIM requires a many-fold increase in target exposure per cycle, and thus higher cumulative exposure compared to conventional microscopy, SIM implementation carries a correspondingly increased risk of target damage and resulting read out failures.

The systems and methods herein for AI-driven enhancement of low-resolution images enable sequencing of a biological sample under diffraction limited imaging conditions and other low-resolution conditions with requisite accuracy and improved cost and operational efficiency. A training set of images obtained under actual or simulated high-resolution and low-resolution conditions may be used to train a model to recover enhanced images, as if taken under high resolution conditions, from unenhanced images taken under low resolution conditions. Trained models implemented in optical sequencing systems provide enhanced resolution power and/or optimized diffraction-limited imaging at low cost and/or reduced photo budget.

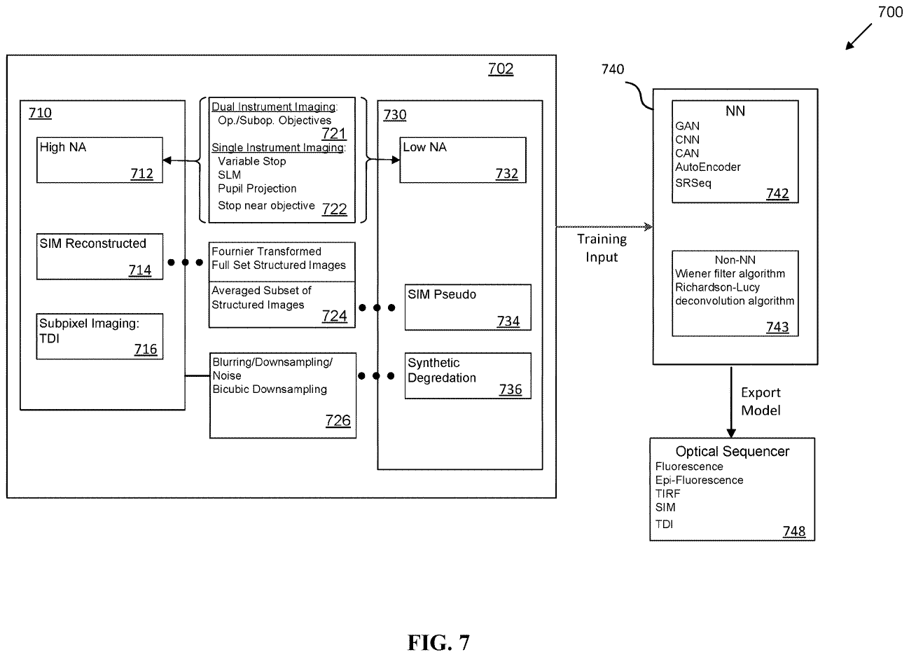

FIG. 7 illustrates various methods of obtaining a training set of image data 702 yielding images characterized by high resolution 710 and low resolution 730, trainable model implementations 740, and optical sequencing systems 748 implementing trained models for AI-driven enhancement of low-resolution images of a biopolymeric material.

A biopolymeric material herein may include nucleic acid materials, e.g., as analytes, primers, templates, or probes. Nucleic acid materials may be referred to herein as terms “nucleic acids,” “nucleic acid molecules,” “nucleic acid sequences,” “polynucleotide,” or “oligonucleotides,” and can comprise a polymeric form of nucleotides of any length, can comprise DNA and/or RNA, and can be single-stranded, double-stranded, or multiple stranded. One strand of a nucleic acid also refers to its complement. Nucleic acid analytes may be gDNA, including DNA variants (e.g., alleles, polymorphs, missense), mtDNA, mRNA, cDNA transcribed from mRNA, non-coding RNA, and small RNA. Nucleic acid materials herein may also include polynucleotide analogues and substitutions, crosslinked polynucleotides, polynucleotide complexes, and non-natural polynucleotides, including, but not limited to, dideoxynucleotides, or biotinylated, aminated, deaminated, alkylated, benzylated, flourophor-labeled polynucleotides. A biopolymeric material herein may also include polypeptides, e.g., as analytes or reagent enzymes. Polypeptide analytes may include functional polypeptides acting, e.g., as effectors, inhibitors, modulators, mediators, transporters, or stimulators in connection with a specific activity affected by a target molecule. Reagent enzymes may include polypeptides involved in nucleic acid synthesis, extension, fragmentation, amplification, or ligation.

FIG. 7 illustrates example methods of obtaining high- and low-resolution images for use in a training set of data herein. As illustrated in FIG. 7, a training set of data may include high resolution images obtained through optical imaging at a high Numerical Aperture (NA) objective 712, reconstruction of raw image data captured using Structured Illumination Microscopy (SIM) 714, or multiple exposure imaging, e.g., Time Delay Imaging (TDI) 716. High resolution images for use in a training set of data may be obtained from one or a combination of such methods. A training set of data, as illustrated, may include low-resolution images obtained through optical imaging at a low Numerical Aperture (NA) objective 732, simulation using raw SIM imaging data 734 obtained from structured raw images 724, or synthetic degradation of high-resolution images 736. Low resolution images for use in a training set of data may be obtained from one or a combination of such methods.

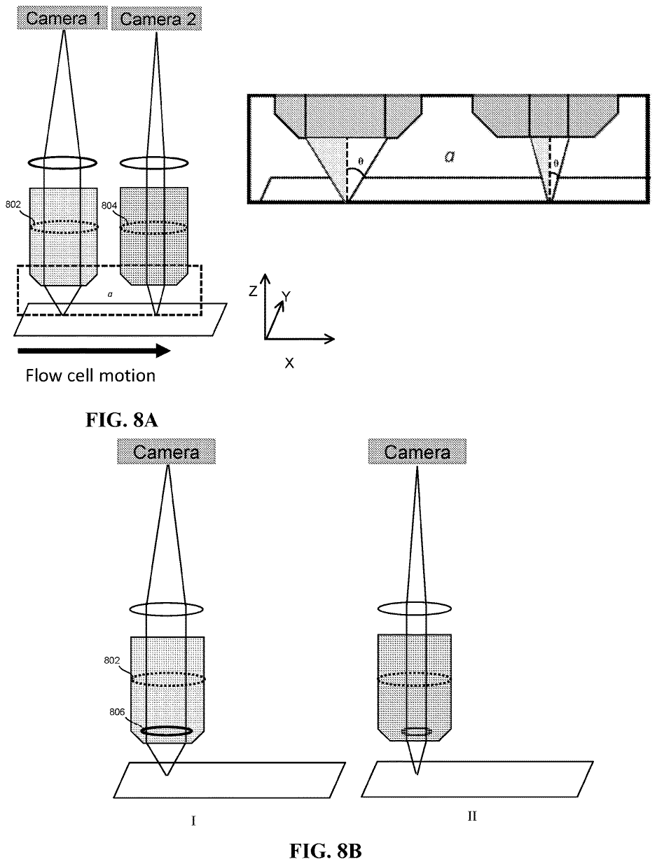

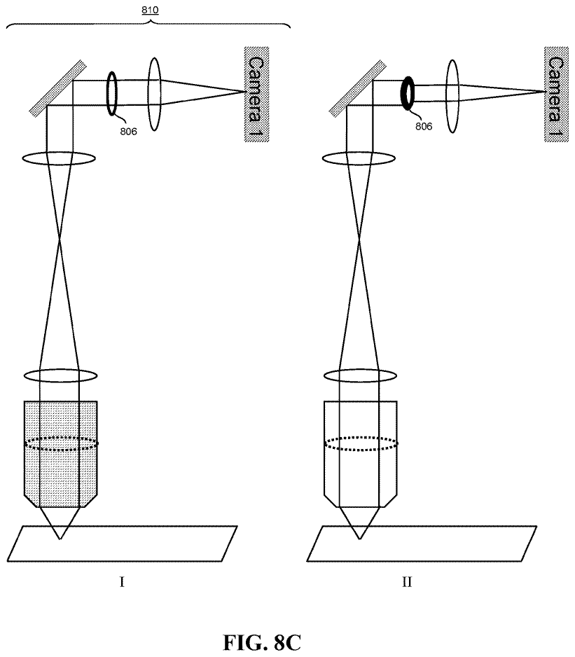

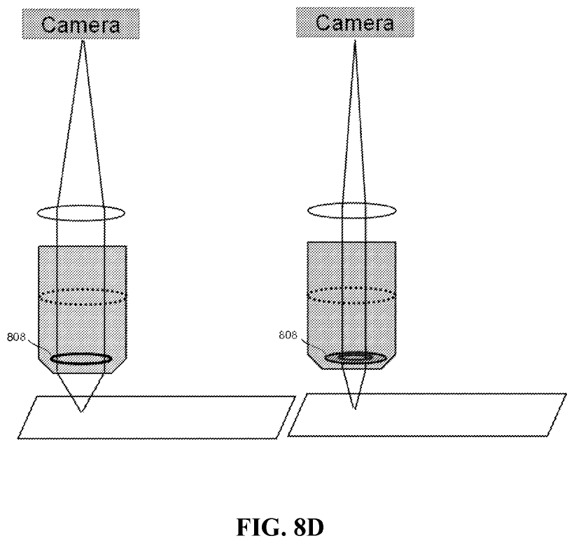

A training set of data may include a plurality of paired images of a collection area containing a sample of biopolymeric material in which one image of each pair is obtained at high resolution and the other at low resolution. In one aspect, a plurality of paired images may include, for each pair of images of a collection area, one image generated at a high Numerical Aperture (NA) 712 and a corresponding image generated at a low Numerical Aperture (NA) 732 for use as respective high- and low-resolution images for training. In one example embodiment such high- and low-resolution images may be obtained from a dual instrument imaging 721. In one example embodiment, illustrated in FIG. 8A, paired image collection is implemented using an optical sequencing system having two cameras with respective high NA and low NA objectives 721. In another example embodiment such high- and low-resolution images may be obtained from single instrument imaging 722. In one example embodiment, illustrated in FIGS. 8B-C, paired image collection is implemented using an optical sequencing system having a single sensor instrument and objective with a mechanically or optically adjustable NA 728. Mechanical adjustment of the NA of an optical sequencing system herein may include a variable stop disposed in a radial plane along a path of transmitted light between an aperture of the instrument and a sensor of a camera of the instrument. Optical adjustment of NA may be affected through implementation of phase modulating via, e.g., a transmissive spatial light module

In one embodiment, example implementations may perform paired low-resolution and high-resolution imaging at each cycle of a sequencing run—a 1:1 paired image to cycle interval. Other example implementations may perform paired imaging at cycle intervals greater than 1:1. For example, certain implementations may perform high resolution imaging may be performed every other cycle, or every second, third, fourth, or fifth cycle, Paired imaging at cycle intervals greater than 1:1 may be implemented to improve photo budgeting in connection with paired low-resolution and high-resolution imaging.

In one aspect, a training set of data may include a plurality of paired synthetic images, in which one image of a pair of high-resolution and low-resolution images is generated from a collection area containing a sample of biopolymeric material and the other image is synthetically generated. According to one embodiment, a high resolution is generated from a collection area containing a sample of biopolymeric material and a corresponding low-resolution image (736) is synthesized from the high-resolution image through degradation of high-resolution image data: In one example, high-resolution images of the plurality of paired synthetic images may be obtained by optical imaging of respective collection areas containing a biopolymeric material at a high Numerical Aperture (NA) objective 712. In another example, high-resolution images may be obtained through reconstruction of raw image data captured using Structured Illumination Microscopy (SIM) 714.

In another example, high-resolution images may be obtained through a subpixel imaging system, e.g., time delay integration (TDI 716) using CCD- or CMOS-based sensors. Subpixel imaging is based on increasing a sample rate to raise the Nyquist frequency, which limits the highest frequency the optical sequencing system can reliably measure (e.g., translate digitally) to one half the sample rate at which the equipment operates. Subpixel imaging is performed by staggering TDI sensors by a subpixel offset and subsampling a given collection area, which effectively doubles the Nyquist frequency along the offset-axis.

Degradation of a high-resolution image to obtain a low-resolution image of a plurality of paired synthetic images may be performed using a degradation model 726. In one aspect, a degradation model with computer-executable instructions is provided that enables bicubic downsampling of a high-resolution to synthesize a corresponding low-resolution image. A degradation model with computer-executable instructions may be provided that enables one or more processes of blurring, downsampling, and/or noise addition to synthesize a low-resolution image from a corresponding high-resolution image data.

According to another embodiment (not illustrated), low-resolution images a plurality of paired synthetic images may be generated from respective collection areas containing a sample of biopolymeric material and a corresponding high-resolution image is synthetically reconstructed from low-resolution image data. A deconvolution model with computer-executable instructions may be provided that enables deconvolution, according to an intensity distribution function, of low-resolution image data to synthetically reconstruct a high-resolution image.

In one aspect, a training set of data may include a plurality of paired images of SIM reconstructed high-resolution images 714 and pre-processed low-resolution images 734. SIM reconstructed high-resolution images 714 may be reconstructed from respective sets of raw images generated from a collection area containing a sample of biopolymeric material in which each raw image is obtained at a phase displacement and angle of structured illumination. In one embodiment, low-resolution images 734 of a plurality of paired images may be pre-processed from respective sets of raw images generated from a collection area containing a sample of biopolymeric material in which each raw image is obtained at a phase displacement and angle of structured illumination. In one example, each low-resolution image 734 of a plurality of paired images may be pre-processed from a subset of raw images of a set of raw images from which a corresponding high-resolution image has been constructed.

In certain embodiments, a training set of data may include a plurality of unpaired images of distinct collection areas containing a sample of biopolymeric material in which a portion of the plurality of unpaired images is obtained at high resolution and another portion at low resolution. Unpaired imaging may be implemented to improve photo budgeting in connection with generated a training set of data herein.

Systems and methods are provided for training an AI-based model 740 based a training set of image data 702. In certain embodiments, systems and methods are provided for supervised training an AI-based model 740 based a training set of image data 702 including a plurality of high-resolution images 710 and low-resolution images 730, in which the AI-based model may be trained to recover enhanced images, as if taken under high resolution conditions, from unenhanced images taken under low resolution conditions. For example, a training set of data for input to an AI-based model for training herein may include plurality of paired images of a collection area containing a sample of biopolymeric material in which one image of each pair is obtained at high resolution and the other at low resolution. A training set of data for input to an AI-based model for training herein may also include a plurality of paired synthetic images, in which one image of a pair of high-resolution and low-resolution images is generated from a collection area containing a sample of biopolymeric material and the other image is synthetically generated. A training set of data for input to an AI-based model for training herein may also include a plurality of paired images of SIM reconstructed high-resolution images and pre-processed low-resolution images. A training set of data for input to an AI-based model for training herein may also include a plurality of unpaired images of respective high resolution and low resolution.

In one aspect, AI-driven resolution enhancement may be implemented, at least in part, based on one or more machine learning techniques, such as deep learning using one or more Neural Networks (NNs) 742. NNs contemplated herein include, but are not limited to, various implementations of Convolutional Neural Networks (CNNs), or other NNs having one or more layers performing convolution. In one example, an SR-Seq convolution-based network is provided implementing AI-driven resolution enhancement. Other example NNs include various implementations of autoencoders, various implementations of Generative Adversarial Networks (GANs), various implementations of Conditional Generative Adversarial Networks (CGANs), and various implementations of cycle-consistent Generative Adversarial Networks (CycleGANs).

In one aspect, AI-driven resolution enhancement may be implemented, at least in part, based on one or more non-Neural Network systems 743. In certain embodiments, systems and methods are provided for supervised training one or more non-Neural Network systems 743 based on a training set of image data 702 including a plurality of high-resolution images 710 and low-resolution images 730, in which the one or more non-Neural Network systems may be trained to recover enhanced images, as if taken under high resolution conditions, from unenhanced images taken under low resolution conditions. In one example, one or more non-Neural Network systems may include a Wiener filter algorithm and/or a Richardson-Lucy deconvolution algorithm.

In one aspect, a trained parameters of AI-based model in a production context may be fine-tuned to a particular optical sequencing system on which the model implements AI-driven resolution enhancement. In one embodiment, fiducial quality may be used as a loss function to fine tune trained parameters to a particular optic sequencing system.

AI-driven resolution enhancement herein may be implemented on various optical sequencing systems. In certain embodiments, AI-driven resolution enhancement herein may be implemented on optical sequencing system utilizing fluorescence microscopy, epifluorescence microscopy, total internal reflection fluorescence microscopy (TIRF), structured illumination microscopy (SIM), direct stochastic optical reconstruction microscopy (dSTORM)); photo-activated localization microscopy (PALM)) and stimulated emission depletion microscopy (STED).

FIGS. 8A-C illustrate examples of optical sequencing systems for generating corresponding images of a collection area at respective high NA 712 and low NA 732 for use as paired images in training. In some embodiments, an optic image system may perform paired imaging in a line imaging implementation, as illustrated in FIG. 2A. In some other, an optic image system for generating corresponding images of a collection area at respective high and low NA may perform paired imaging in an area imaging implementation, as illustrated in FIG. 2B. In still other embodiments, an optic images system may generate corresponding images of a collection area at respective high and low NA in a line imaging implementation in either a discrete point-and-shoot operation or a continuous scanning operation as illustrated in FIG. 2B.

FIG. 8A illustrates an optic imaging system for implementing paired low- and high-resolution imaging having two sensor instruments arranged in parallel on the z axis, each with a respective camera, and each with a different objective, one (802) with a high NA (large θ) for obtaining high-resolution images and the other (804) having a low NA (small θ) for generating corresponding low-resolution images. The sensor instruments may be disposed in various arrangements along the x and y axes. In the example of FIG. 8A, sensor instruments collect images in a tandem arrangement along the x axis such that, in a line imaging implementation, collection of respective low-resolution and high-resolution images progresses one line at a time. Alternatively, collection may occur in a parallel arrangement along the x axis, two lines at a time. In certain implementations, the cameras perform imaging synchronously, two respective collection areas at a time, in which case corresponding high and low images of a collection area for paired imaging not obtained serially. A registration module may be implemented to register corresponding images for pairing. Further, a distortion correction coefficients module may also be implemented to correct any lens distortion A between respective objectives.

In some embodiments, an optic imaging system for implementing paired low-and high-resolution imaging having a single sensor instrument and objective with mechanically or optically adjustable NA. For example, FIG. 8B illustrates an optic imaging system having single sensor instrument including a variable stop 806, e.g., a mechanical iris. Variable stop 806 mechanically limits the angle of the physical cone of light passing through the system from an on-axis object point, and thus allows for mechanical adjustment of the θ value of NA between a high NA value (I) and low NA value (II). In one aspect, the single sensor instrument performs imaging at high NA and low NA serially, switching between stop settings one collection area at a time. In one aspect, the instrument may be switched between stop settings at an interval greater than one collection area at a time.

Variable stop 806 may be disposed at different radial planes along the path of transmitted light. For example, a variable aperture 806 may be disposed at or adjacent an aperture of the single sensor instrument. Alternatively, variable stop 806 may be disposed adjacent an object side of the objective, or along the optic path between the aperture and objective. In certain implementations, variable stop 806 may be disposed between the image side of the objective and the camera sensor. For example, FIG. 8C viable stop 806 may disposed within a pupil extension 810.

Optical adjustment of NA may be implemented via amplitude modulating using a transmissive spatial light module (SLM) 808, e.g., liquid crystal SLM, or a reflective SLM, as illustrated in FIG. 8D. The SLM can be placed at any of the locations of the variable stop 806. Like the variable stop, the SLM can decrease the entrance and/or exit pupil radius, which effectively reduces the resolution of the sequencer.

In some implementations, paired images may be aligned (e.g., to sub-pixel resolution) based, at least in part, on information of one or more fiducials located in the images and via one or more data processing operations. A specific example of aligning the two images of a paired image is as follows. Flow cells are marked with fiducials at pre-determined locations. A set of coefficients (e.g., based on an affine transform) are calculated based on locations of the fiducials in the two images and the set of coefficients is used to formulate transformed images as an intermediate alignment of the two images to a virtual reference frame, forming two respective transformed images. Then, the transformed images are interpolated to produce aligned images. Interpolation is performed variously via any combination of nearest-pixel, linear, quadratic, cubic, and/or higher order techniques, as well as band-limited interpolation techniques. A variant of the foregoing technique aligns the high-resolution image of the pair to the low-resolution image of the pair instead of aligning each of the images to a virtual reference frame. In some implementations, aligning the two images of a paired image includes correction of optical distortion, such as via an iterative curve fitting procedure to estimate distortion coefficients.

In some implementations, aligning the two images of a paired image introduces undesirable artifacts into an image. For example, if aligning shifts an image in a particular axis (such as the x-axis), then zero padding is used to maintain a same image resolution. If the two images of a pair are shifted by different amounts, then respective different zero padding amounts are used for each image of the pair. In some scenarios, the respective different zero padding amounts lead to reduced efficiency during training. In some implementations, all or any portions of zero padding of images (e.g., all or any portions of some edges of images) are discarded during training.

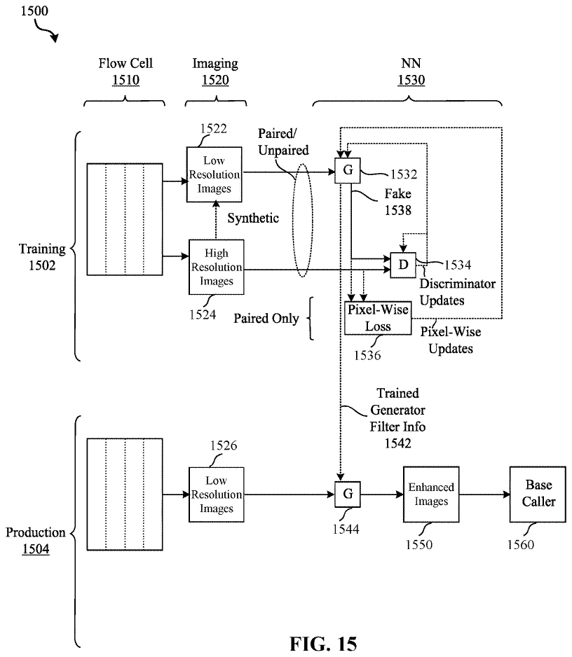

In any of the training contexts of FIGS. 15-17 the more closely sequence data in the training context emulates the ground truths of sequence data in the production context, the more accurate trained model parameters implemented in a production AI model will be in predictively generating sufficiently enhanced images for base calling. To that end, low-resolution images obtained in a training context should correspond closely in quality to that of the low-resolution images generated for AI enhancement in the production context. Similarly, the high-resolution images obtained in the training context should model an enhanced image with quality closely corresponding to that of a high-resolution image.

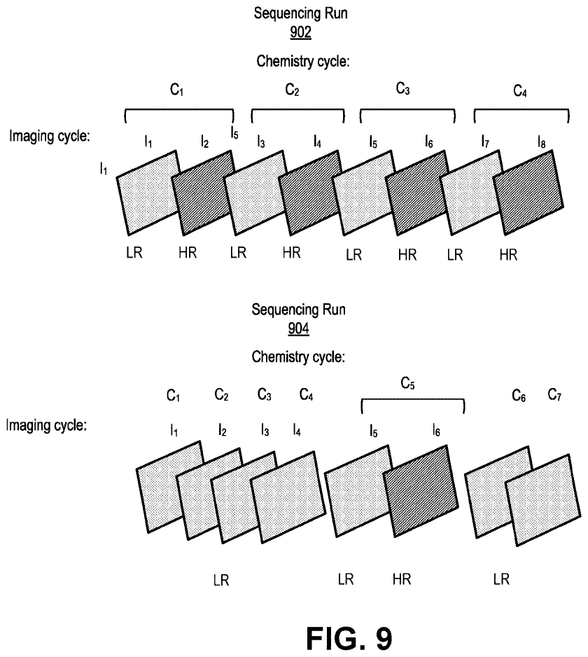

FIG. 9, illustrates an example of a sequencing run 902 in which a paired low-resolution image and a high-resolution image of the same sample target are obtained every cycle during the sequencing run 902. Such an imaging cycle may require paired imaging more frequently than needed to properly train the AI for image enhancement. The generation of paired images at every cycle may generate a higher amount of training data, but the frequent imaging may cause greater photodamage and ultimately become less beneficial in training the AI in later cycles of the sequencing run 902. The result of the photodamage caused by generation of paired images at every cycle may ultimately affect the ability of the AI to properly enhance images during production due to the images being input into the AI during production failing to be similarly affected.

In certain embodiments, training data and production data are obtained under identical conditions—the same instruments, channel chemistries, image cycles, and photon budget. However, because training data obtained through paired image collection, as described herein, may require target imaging at both high resolution and low resolution, the photon budget for paired image sequencing may be significantly higher than that of individually generating low-resolution images or high-resolution images in production sequencing. Thus, the loss of Signal-to-Noise Ratio (SNR), as a measure of the quality of the data of a signal of interest, may cascade more steeply and after fewer cycles during paired image sequencing than the loss of optical SNR occurring during production sequencing. In that regard, training data may not appropriately emulate interdependent ground truths pertaining to photodamage and optical SNR in production data. As a consequence, a production AI model may implement model parameters insufficiently calibrated to enhance low-resolution images to match the quality of high-resolution images in production.

To address this disparity between training and production data, and thus better align training data obtained through paired image collection with ground truths of acquired photodamage in production data, while also limiting the photodamage during training and production to produce images having a higher optical data quality (e.g., as measured by SNR or otherwise), some implementations may perform paired image collection at cycle intervals, e.g., sequencing run 904 of FIG. 9. Here, rather than performing paired low-resolution and high-resolution imaging at each cycle—a 1:1 paired image to cycle interval—example implementations may perform paired imaging at cycle intervals greater than 1:1. In one example, a system may reduce power imaging during cycles between cycle intervals of paired imaging. Under some circumstances, low-resolution imaging between cycle intervals may be performed to avoid biasing the model value for photo budget features of training data below the actual value of the feature in ground truth, e.g., accounting for actual photodamage and/or phasing/prephasing in production.

According to example implementations, the particular cycle interval may depend on the number of paired images required in a given training context. The amount of training data may be increased by the number of paired images that are produced for training the AI. However, the amount of photodamage may increase and, as a result, the optical data quality (e.g., as measured by SNR or otherwise) may decrease as the number of paired images that are produced increases.

In some implementations, paired imaging may be performed dynamically, in which either the cycle interval may be adjusted during a sequencing run. The adjustment of the cycle interval may be made at one or more predefined portions of the sequencing run. For example, during the early cycles of a sequencing when imaging is obtained at relatively high SNR compared to later cycles, the imaging may be performed at the highest cycle interval. Under certain circumstances, imaging at optimal cycle interval in the earlier cycles, flattens the curve of logarithmic decline of the quality of data of a signal of interest caused by acquired photodamage. Then, during the later cycles of sequencing where relatively low SNRs may no longer support imaging at optimal cycle interval, an adjustment is made to reduce the cycle interval.

In some implementations, paired images are disadvantageous such as due to higher image collection cost, longer data processing time, and/or poorer base calling accuracy. For example, processing a same sample two times (a first time at a first excitation power for first elements of the paired images and a second time at a second excitation power for second elements of the paired images) degrades the sample leading to poorer base calling accuracy. Thus, in some implementations, unpaired images are advantageous. Processing respective samples at respective high- and low-resolution reduces sample degradation as each sample is processed only a single time.

In some implementations, capturing unpaired images comprises capturing two pluralities of images. A first of the pluralities is imaged at a low power and a second of the pluralities is imaged at a high power of the same or a different assay. In some implementations, the pluralities are of tiles of a same flow cell. In some implementations, the pluralities are of tiles of different flow cells. In some implementations, at least one of the tiles imaged at the low power is also imaged at the high power. In some implementations, none of the tiles imaged at the low power are also imaged at the high power.

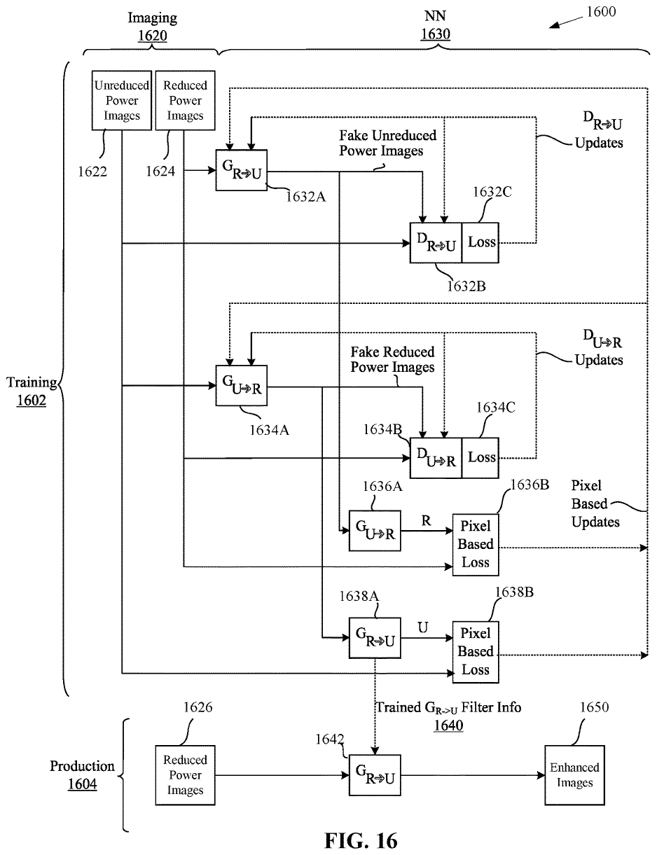

The unpaired images of the flow cells are usable as all or any portions of a training set of unpaired images for training NNs according, e.g., to any of FIG. 15 and FIG. 16.

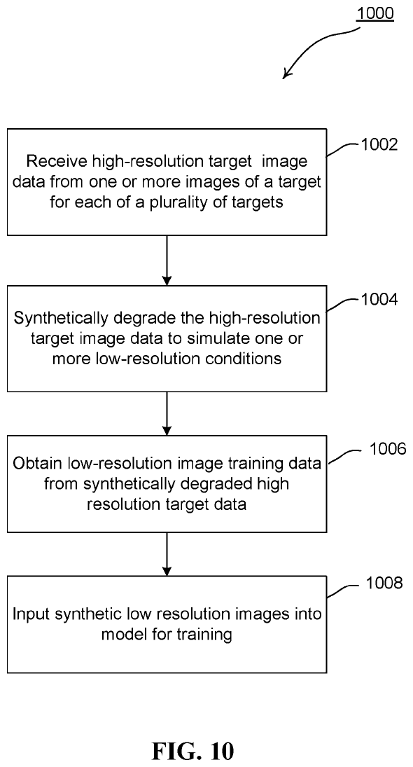

FIG. 10 illustrates a process 1000 of computationally degrading a high-resolution image to obtain a paired synthetic low-resolution image. One or more portions of the process 1000 may be performed by one or more computing devices. For example, the one or more portions of the process 1000 may be performed by one or more server devices and/or one or more imaging systems. One or more portions of the process 1000 may be implemented by a digital imaging system operating on one or more computing devices. One or more portions of the process 1000 may be stored in memory as computer-readable or machine-readable instructions that may be executed by a processor of the one or more computing devices. Though portions of the process 1000 may be described herein as being performed by a digital imaging system operating on one or more computing device, the process 1000 may be performed by another system operated by a computing device or distributed across multiple computing devices.

As illustrated in FIG. 10, the process 1000 includes receiving, at 1002, high-resolution target image data from one or more images of a target for each of a plurality of targets. The high-resolution target image data may include image data of a flow cell tile that may be collected by imaging under high-resolution conditions, producing the high-resolution image of a pair of images. At 1004, the high-resolution target image data may be synthetically degraded to simulate one or more low-resolution conditions. For example, the processing, at 1004, may include applying a set of variables to synthetically degrade the high-resolution target image data in a manner that simulates one or more low-resolution conditions. At 1006, the low-resolution image training data may be obtained from synthetically degraded high resolution target data. At 1008, the low-resolution image training data may be input into a NN or non-NN model for training.

Low-resolution conditions may be simulated based on a variety of intrinsic and extrinsic conditions attending the sequencing operations contemplated herein. For example, low resolution conditions may result from operating an imaging instrument beyond a diffraction limit, e.g., Abbe diffraction limit of the instrument; employing a lens or lenses having a low Numerical Aperture (NA) objective value insufficient to permit the imaging systems to resolve wavelengths of adjacent targets; acquiring images having a large Point Spread Focus (PSF).

In certain implementations, synthetic low-resolution images may be generated channel-wise, where, for example in two-channel chemistry, synthetic low-resolution images are generated from each of the green-channel and blue-channel high resolution images of a given cycle. Alternatively, synthetic low-resolution images may be generated as single images per cycle from single integrated high-resolution images of merged channel images.

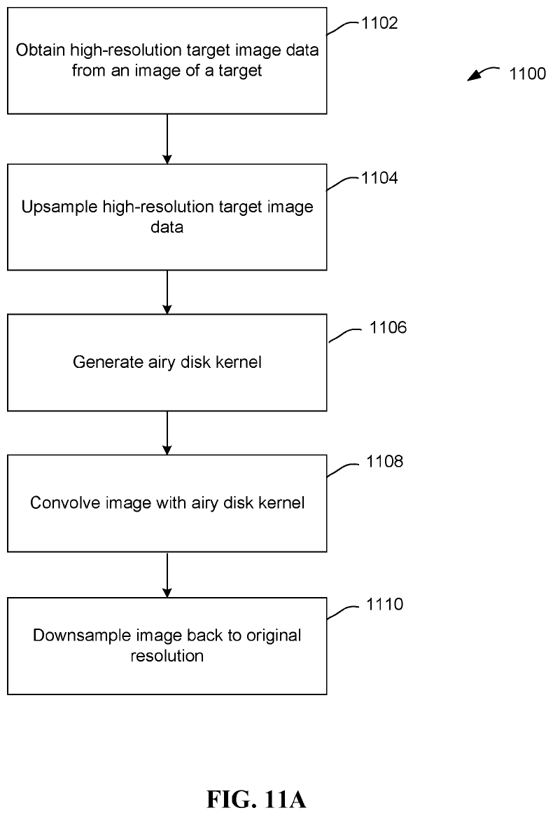

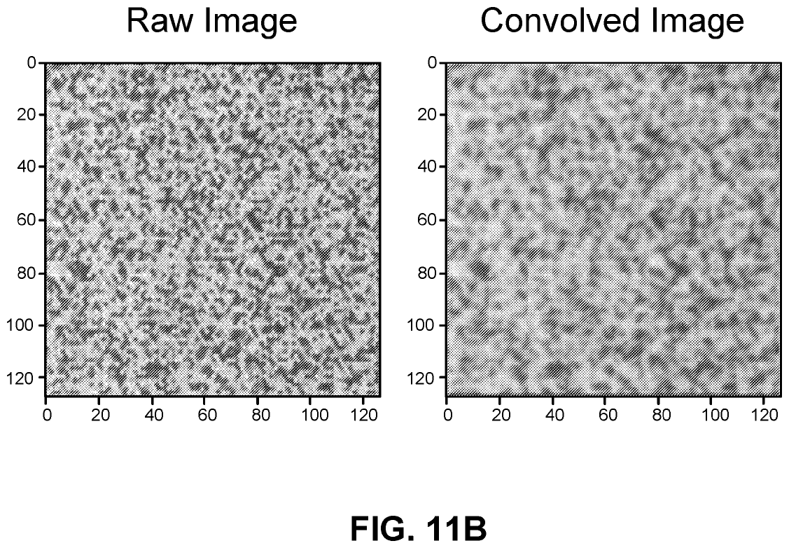

Described herein are examples for synthetically degrading high-resolution target image data to simulate one or more low-resolution conditions for a low-resolution image that may be used in synthetic high resolution-low resolution image pairs. FIG. 11A shows an example process 1100 that may be implemented for synthetically degrading a raw high-resolution image comprised of high-resolution target image data to generate a low-resolution image. As shown in FIG. 11A, the raw high-resolution image may be input into a degradation function/model that may output the synthetic low-resolution image. The process 1100 may be implemented on one or more computing devices, as described herein. For example, the process 1100 may be implemented by a degradation function/model used for generating paired images, as described herein.

As shown in FIG. 11A, a high-resolution target image data may be obtained from a raw image of the target at 1102. The process 1100 may be performed for one or more (e.g., each) high-resolution image of the target. At 1104, the high-resolution target image data may be upsampled. An upsampling function may be configured to add more pixels per unit of measure. The added pixels may be interpolated based on the colors of neighboring pixels in the image, which may reduce the quality of the high-resolution target image data. The high-resolution target image data may be upsampled by a predefined factor. For example, the high-resolution target image data may be upsampled by a factor of 2×, 5×, 10×, 20×, or another factor. The upsampling may be performed at a predefined factor to minimize effects of aliasing.

At 1106, an airy disk kernel may be generated. The airy disk kernel may be a matrix (e.g., convolution matrix) that models the diffraction pattern of a circular aperture for blurring the high-resolution target image data. The configuration and/or values of the airy disk kernel may depend on the NA of the lens at which the raw high-resolution image was taken. The NA of the objective lens may affect the size and shape of the point spread function (PSF) and, as a result, the configuration or values of the airy disk kernel that is applied to the high-resolution target image data. The configuration and/or values of the airy disk kernel may also, or alternatively, depend on the NA of the lens of the imaging device that is being used in production. For example, the configuration and/or values of the airy disk kernel may be adjusted to simulate different low-resolution image data that may be obtained from imaging devices that include lenses with different NAs. A different PSF may be applied depending on the different lenses that may be used in production to allow for training of models for different imaging devices.

The airy disk kernel may be generated at 1106 by taking a diffraction-limited image from a sequencing device with a given NA and synthetically generating a paired low-resolution image with a reduced NA. This may be accomplished by convolving the image with a Gaussian blurring kernel, as described herein. For example, the full width half max (FWHM) of the airy pattern may be determined as shown in equation (5)

$$FWHM = 1.028 \frac{λ}{D} \qquad ( 5 )$$

where λ is the wavelength and D is the entrance pupil diameter. The relationship between NA and the entrance pupil diameter D may be approximately determined using equation (6)

$$NA = n sin ( θ ) \approx \frac{nD}{2 f} \qquad ( 6 )$$

where θ is a half-angle of the cone of light that can enter the microscope, n is the index of refraction, D is the entrance pupil diameter, and f is the focal length. From equation (5) and equation (6), the airy pattern FWHM may be determined from NA as shown in equation (7)

$$FWHM = 1.028 \frac{n λ}{2 NAf} \qquad ( 7 )$$

where n is the index of refraction, λ is the wavelength, and f is the focal length. The airy pattern may be approximated with an equivalent FWHM. The FWHM of a Gaussian distribution may be determined using equation (8)

$${FWHM}_{Gaussian} = 2 σ \sqrt{2 ln ( 2 )} \qquad ( 8 )$$

where σ is the standard deviation of a Gaussian distribution and is assumed to be the same in both x- and y-axes. The standard deviation σ may be calculated for the Gaussian approximation by combining equation (7) and equation (8), as shown in equation (9)

$$σ = 1.028 \frac{n λ}{4 \sqrt{2 ln ( 2 )} NAf} \qquad ( 9 )$$

Based on equations (5)-(9), a Gaussian approximation may be defined for the airy pattern of a microscope given a set of optical parameters (n, λ, NA, f). A 2D Gaussian is defined in equation (10), which assumes zero-mean (x_o=y_o=0), σ_x=σ_y=σ, and that A is set such that the integral of the equation over all x and y=1.

$$f ( x , y ) = A exp ( - ( \frac{{( x - {x}_{0} )}^{2}}{2 {σ}^{2}} + \frac{{( y - {y}_{0} )}^{2}}{2 {σ}^{2}} ) ) \qquad ( 10 )$$

As the image from the sequencing device may already be blurred by the optics, the blurring may be further accounted for as described herein. For example, based on the assumption that the airy pattern of the physical optics is also a Gaussian distribution, equation (9) may be used to calculate the standard deviation of the Gaussian blurring kernel due to the optics (σ_{optics}), as shown in equation (11) and similarly in equation (12)

$${σ}_{optics} = 1.028 \frac{n λ}{4 \sqrt{2 ln ( 2 )} {NA}_{optics} f} \qquad ( 11 )$$

$${σ}_{target} = 1.028 \frac{n λ}{4 \sqrt{2 ln ( 2 )} {NA}_{target} f} \qquad ( 12 )$$

The amount of blur may be calculated that is applied (σ) to achieve the target blur (σ_{target}) after accounting for the optical blur (σ_{optics}) as shown in equation (13)

$${σ}^{2} = \sqrt{{σ}_{target}^{2} - {σ}_{optics}^{2}} \qquad ( 13 )$$

After calculating σ, the value can be inserted into equation (10) to output the value of the airy disk blurring kernel.

At 1108, the high-resolution target image data may be convolved with the airy disk kernel. The output of the convolution may include one or more low-resolution conditions for low-resolution image data that may be used in synthetic HR-LR image pairs. FIG. 11B provides two-channel sample image tiles of a high-resolution image (raw image) and synthetic low-resolution images (convolved image). As a result, the low-resolution image may be a synthetic image that is based on actual features of a raw high-resolution target image. The convolution of the airy disk kernel may simulate noise that may be introduced in a raw low-resolution image (e.g., based on a predefined NA of a lens) that may be used during production in an imaging device.

At 1110, upsampled image data may be downsampled back to the original resolution. The downsampled image may be used for the HR-LR image pairs, as described herein.

Various methods described herein are particularly suited to SIM imaging systems and techniques. According to certain methods, high-resolution target image data is obtained through SIM reconstruction of six or more raw images based on any combination of phase displacements and angles of structured illumination. In one embodiment, six raw images per target are obtained based on three phase displacements and at two angles, resulting in two sinusoidally varying illumination patterns per phase. Alternatively, nine raw images may be obtained based on three phase displacements and at three angles, resulting in three sinusoidally varying illumination patterns per phase. Various phases and angles may be selected as appropriate. For example, the phases or angles may be selected from one or more of 0°, 60°, 120°, and 240°. In some instances, the raw structured illumination images are taken at, near, or beyond the Abbe diffraction limit of the attendant imaging instrument.

SIM reconstruction methods for training a model herein may involve Fourier Transfer processing, which entail computational steps for each raw image, generating frequency domain content based, at least in part, on frequency content engendered by sinusoidally varying illumination patterns at each angle of illumination used to generate the raw images, merging frequency domain content of the raw images, and, through, e.g., inverse Fourier Transfer, reconstruct a high-resolution image in a spatial domain.

In connection with these or other SIM-based methods, low-resolution training image data may be obtained based on the same raw images used to generate corresponding high-resolution data. According to certain methods, low-resolution training image data are obtained based on a reduced number of raw images compared to the raw images used to generate corresponding high-resolution training data. For example, low-resolution training image data may be obtained based on between two and four raw images, preferably two or three images. In certain preferred embodiments, low-resolution training image data includes a set of pre-processed low resolution images obtained through preprocessing of raw images used to generate the set of high-resolution images. For example, preprocessing may include computational steps that sums raw image data of between, e.g., two and four raw images, into a single image substantially proportional to a fluorophore density distribution of the target.

In one example, a subset of high-resolution images of a training set of images is generated through SIM implementation in which a plurality of raw structured illumination images taken of a target—typically six or nine images—are reconstructed as a single high-resolution image through a Fourier transform. In some instances, the raw structured illumination images are taken at, near, or beyond the Abbe diffraction limit of the attendant imaging instrument. A subset of low-resolution images of a training set of images is generated through pre-processing of at least two, but less than the entirety, of the plurality of raw structured illumination parameters are averaged to derive a single low-resolution image. Preferably, two or four raw structured illumination images are averaged to derive each low-resolution image. The training set of images is input to a training model and a set of trainable parameters are optimized to training set to extract features of the subset of low-resolution data that may be processed to predictively yield respective high-resolution images that match corresponding SIM reconstructed images of the subset of high-resolution images with high fidelity.

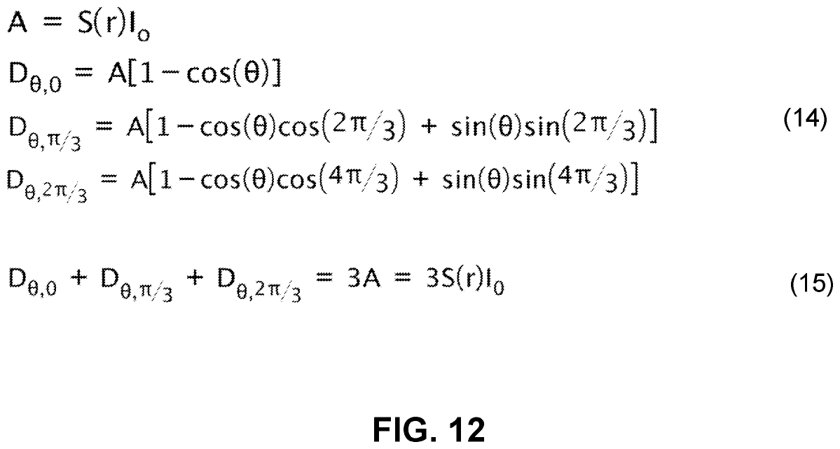

In certain embodiments, multiple modulated raw images are captured of one or more sample targets under structured illumination. In one example, the number of modulated raw images is either six images at two illumination angles and three phases or nine images at three illumination angles and three phases. High resolution image training data is generated via SIM reconstruction of modulated raw images using a SIM Reconstruction Algorithm (SIM-RA) as described herein, e.g., FIG. 4, and as further elucidated in Lal et al. Low resolution image training data are generated from between two and four images of the modulated raw image set using an averaging algorithm in the example of FIG. 12, using three phase shifted images at φ=0°, 120°, and 240° at a single angle θ. As shown, a low-resolution image may be obtained through phase matching and summing the three phase-shifted images in accordance with equation (14) of FIG. 12. And, in accordance with equation (15) of FIG. 12, the sum of the three phase-shifted images D_{θ}(r) is equal to 3S(r)Iₒ, where S (r) represents the fluorophore density distribution of the target image, Iₒ represents a 2D spatial distribution vector, and D_{θ}(r) is proportional to S(r), uniformly illuminated by Iₒ.

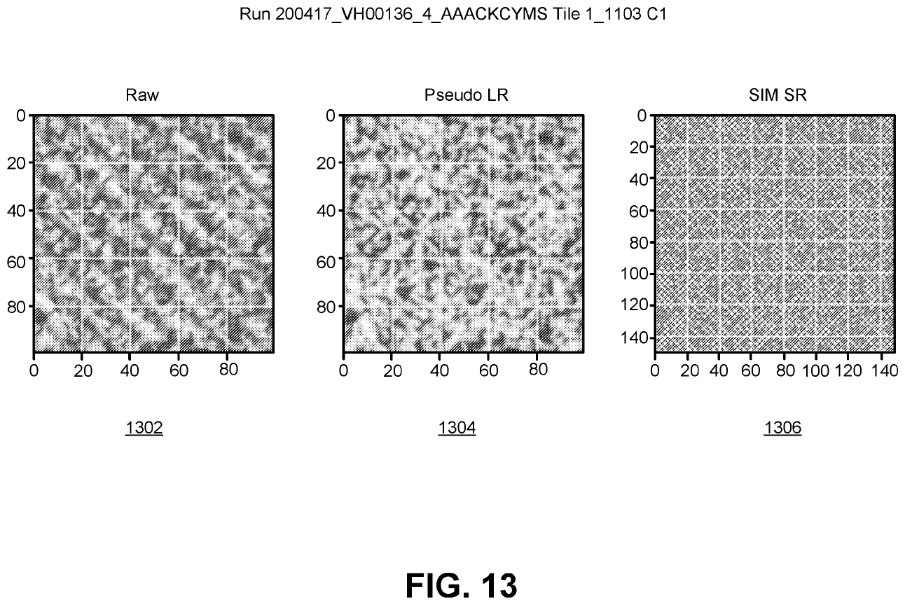

FIG. 13 provides an example raw modulated image 1302, low resolution image (Pseudo LR) 1304 and SIM reconstructed high resolution image (SIM SR) 1306 of the types used with certain embodiments. The raw modulated image 1302 was captured using an Illumina NextSeq® System sequencer at 226 nm pixel size and a 400 nm pitch using two channel (green and blue) chemistry. The low-resolution image 1304 was computationally obtained at high spatial frequency (green: 500 nm@% λ=615 nm; blue: 400 nm@λ=490 nm) using the equations of FIG. 12. And the high-resolution image 1106 was SIM reconstructed to a lowered spatial frequency (green: ~250 nm; blue: ~220 nm) at 1.5× enhancement at 150 nm pixel size.

The low-resolution image 1304 is a version of modulated raw images 1302. For example, a number of raw images 1302 may be taken and averaged to generate the low-resolution image (Pseudo LR) 1304. The low-resolution images 1304 may be input as training data for training the AI, as described herein. The SIM reconstructed high resolution image 1306 may be paired with the low-resolution image 1304 as a target to train the AI.

As described herein, SIM and other super-resolution image collection and reconstruction processes may require up to a six-to nine-fold increase in photon budget per target corresponding to the number of required image exposures and sophisticated reconstruction algorithms to transform the multiple diffraction-limited images into a single, high-resolution image. Additionally, as speed is a critical parameter for NGS, the need to collect six to nine image exposures for a typical SIM implementation, plus the additional time to actuate the motors to shift the phase and angles of the fringes, is undesirable. The increased image exposures and additional computational requirements needed for SIM implementation greatly increase power consumption during a given sequencing run compared to conventional microscopy.

Furthermore, high-resolution imaging systems, such as SIM systems and other super-resolution imaging systems, may use more hardware or more expensive hardware in the optical sequencing system that are used in production to generate higher-quality images. For example, production sequencing systems (e.g., ILLUMINA's NOVASEQ systems) may require high NA objectives or for flow cell to be perfectly flat for NA objectives. Production sequencing systems that can operate an optical sequencing system with lower NA objectives may utilize less hardware or less costly hardware and may operate under less stringent conditions.

Described herein are sequencing systems that utilize digital imaging systems for optical resolution enhancement of an image taken on an optical sequencing system. The digital imaging system may leverage artificial intelligence (AI) or other machine learning to computationally enhance a lower-resolution image to generate a higher-resolution image. For example, the digital imaging system may leverage AI to enhance a lower-resolution image to generate a super-resolution image, Various embodiments herein provide AI-driven resolution enhancement of sequencing images captured under structured illumination or other SR techniques implemented in NGS.

In certain implements, methods are provided for training an AI-based model to produce an enhanced resolution image from a reduced set of raw images of a target captured under structured illumination. For example, using certain AI-driven resolution enhancement methods herein, SIM reconstruction is conducted using two to four raw images, rather than the six to nine images typically required in unaided SIM.

In the same or other implements, methods are provided for training an AI-based model to produce an enhanced resolution image from a set of raw images of a target captured under structured illumination at low-resolution. AI-driven resolution enhancement as described provides SIM implementation at reduced image collection time and power consumption compared to unaided SIM provides efficiency gains in system operations and output, reduces operation costs, and improves the reliability of base-call read outs Trained parameters according to any of the models described herein (e.g., models of FIG. 15, 16, 17, or 18A-B) may be implemented in one or more AI or ML algorithms in a program for processing raw structured image data of a target in a SIM production operation. Using the trained parameters, AI or ML programs may generate a SIM reconstructed high-resolution using less raw structured image data than would otherwise be required to perform a standard Fornier transform. For example, parameters trained with image data obtained from two raw structured illumination images would require no more than the same type and amount image data to SIM reconstructed high-resolution images in a production context. Thus, for example, rather than the six or nine structured images required per exposure in a standard computational transform, AI-driven resolution enhancement in accordance with the certain embodiments of the disclosure may generate a reconstructed high-resolution image based only on two images.

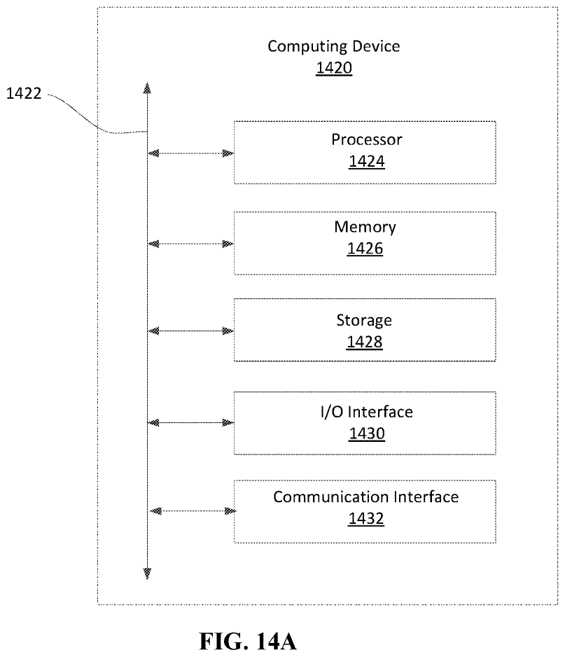

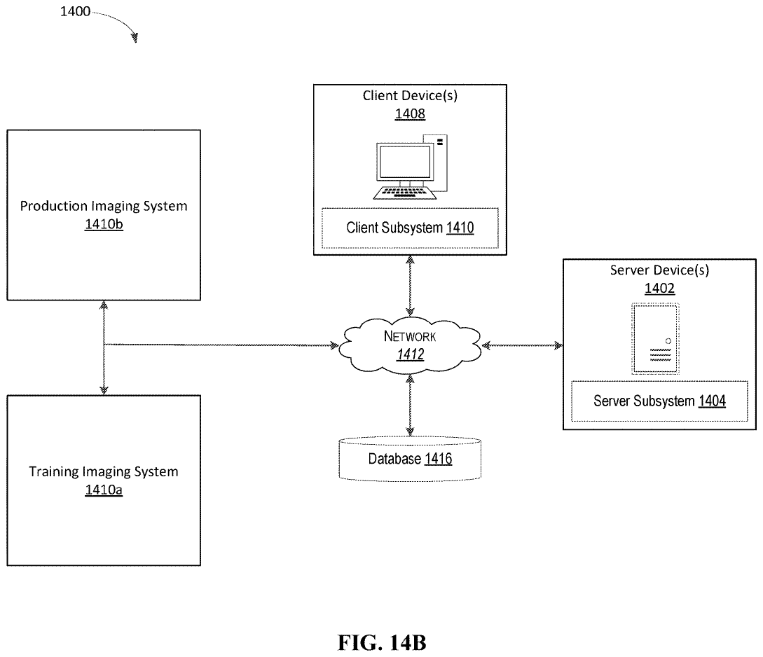

FIG. 14A is a block diagram illustrating an example computing device 1420. One or more computing devices such as the computing device 1420 may implement one or more features for generating and/or processing sequencing tasks, as described herein. For example, the computing device 1420 may comprise one or more of the imaging systems 1410a, 1410b, the client device 1408, and/or the server device(s) 1402 shown in FIG. 14B.

The computing device may comprise an instrument such as an optic sequencing device having a processor implementing one or more trained filters, in which the instrument is configured to obtain, as an input, low-resolution target image data from one or more low-resolution images of a target captured by one or more sensors of an optic imaging system and recover from the low-resolution target image data, via the trained filter, an enhanced resolution image, as an output, for use in base calling.

As shown by FIG. 14A, the computing device 1420 may comprise a processor 1424, a memory 1426, a storage device 1428 an I/O interface 1430, and/or a communication interface 1432, which may be communicatively coupled by way of a communication infrastructure 1422. It should be appreciated that the computing device 1420 may include fewer or more components than those shown in FIGS. 14A and B. For example, where the computing device 1420 comprises an imaging system, such as the imaging system 100 shown in FIG. 1 or the SIM imaging systems 601 of FIG. 6, it may include additional optical elements and/or other portions of a sequencing device, as described herein.

The processor 1424 may include hardware for executing instructions, such as those making up a computer program. In examples, to execute instructions for dynamically modifying workflows, the processor 1424 may retrieve (or fetch) the instructions from an internal register, an internal cache, the memory 1426, or the storage device 1428 and decode and execute the instructions. The memory 1426 may be a volatile or non-volatile memory used for storing data, metadata, computer-readable or machine-readable instructions, and/or programs for execution by the processor(s) for operating as described herein. The storage device 1428 may include storage, such as a hard disk, flash disk drive, or other digital storage device, for storing data or instructions for performing the methods described herein.

The I/O interface 1430 may allow a user to provide input to, receive output from, and/or otherwise transfer data to and receive data from the computing device 1420. The I/O interface 1430 may include a mouse, a keypad or a keyboard, a touch screen, a camera, an optical scanner, network interface, modem, other known I/O devices or a combination of such I/O interfaces. The I/O interface 1430 may include one or more devices for presenting output to a user, including, but not limited to, a graphics engine, a display (e.g., a display screen), one or more output drivers (e.g., display drivers), one or more audio speakers, and one or more audio drivers. The I/O interface 1430 may be configured to provide graphical data to a display for presentation to a user. The graphical data may be representative of one or more graphical user interfaces and/or any other graphical content.

The communication interface 1432 may include hardware, software, or both. In any event, the communication interface 1432 may provide one or more interfaces for communication (such as, for example, packet-based communication) between the computing device 1420 and one or more other computing devices or networks. The communication may be a wired or wireless communication. As an example, and not by way of limitation, the communication interface 1432 may include a network interface controller (NIC) or network adapter for communicating with an Ethernet or other wire-based network or a wireless NIC (WNIC) or wireless adapter for communicating with a wireless network, such as a WI-FI.

Additionally, the communication interface 1432 may facilitate communications with various types of wired or wireless networks. The communication interface 1432 may also facilitate communications using various communication protocols. The communication infrastructure 1422 may also include hardware, software, or both that couples components of the computing device 1420 to each other. For example, the communication interface 1432 may use one or more networks and/or protocols to enable a plurality of computing devices connected by a particular infrastructure to communicate with each other to perform one or more aspects of the processes described herein. To illustrate, the sequencing process may allow a plurality of devices (e.g., a client device, sequencing device, and server device(s) to exchange information such as sequencing data and error notifications.

In addition to what has been described herein, the methods and systems may also be implemented in a computer program(s), software, or firmware incorporated in one or more computer-readable media for execution by a computer(s) or processor(s), for example. Examples of computer-readable media include electronic signals (transmitted over wired or wireless connections) and tangible/non-transitory computer-readable storage media. Examples of tangible/non-transitory computer-readable storage media include, but are not limited to, a read only memory (ROM), a random access memory (RAM), removable disks, and optical media such as CD-ROM disks, and digital versatile disks (DVDs).

FIG. 14B illustrates a schematic diagram of a system environment (or “environment”) 1400 for training and applying a model for AI-driven resolution enhancement of sequencing images, as described herein.

As illustrated, the environment 1400 includes one or more server device(s) 1402 connected to one or more training imaging systems 1410a and/or production imaging systems 1410b. For example, the one or more server devices 1402 may be connected to the one or more training imaging systems 1410a, production imaging systems 1410b, and/or client device(s) 1408 via a network 1412.

As shown in FIG. 14B, the server device(s) 1402, the training imaging systems 1410a and/or production imaging systems 1410b may communicate with each other via the network 1412. The server device(s) 1402 may also communicate with the client device(s) 1408. In particular, the server device(s) 1402 may send data to the client device(s) 1408, including sequencing data or other information and the server device(s) 1402 may receive input from users via client device(s) 1408. The network 1412 may comprise any suitable network over which computing devices and/or controllers of an imaging system may communicate. The network 1412 may include a wired and/or wireless communication network. Example wireless communication networks may be comprised of one or more types of radio frequency (RF) communication signals using one or more wireless communication protocols, such as a cellular communication protocol, a wireless local area network (WLAN) or WIFI communication protocol, and/or another wireless communication protocol. In addition, or in the alternative to communicating across the network 1412, the server device(s) 1402, the training imaging system 1410a, and/or the production imaging system 1410b may bypass the network 1412 and may communicate directly with one another.

The client device(s) 1408 illustrated in FIG. 14B may comprise various types of client devices. In examples, the client device 1408 may include non-mobile devices, such as desktop computers or servers, or other types of client devices. In other examples, the client device 1408 may include mobile devices, such as laptops, tablets, mobile telephones, or smartphones.

Each client device 1408 may generate, store, receive, and/or send digital data. In particular, the client device 1408 may receive sequencing metrics from the sequencing device 1414. Furthermore, the client device 1408 may communicate with the server device(s) 1402 to receive one or more files comprising nucleotide base calls and/or other metrics. The client device 1408 may present or display information pertaining to the nucleotide-base call within a graphical user interface to a user associated with the client device 1408.

As further illustrated in FIG. 14B, each client device 1408 may include a client subsystem 1410. The client subsystem 1410 may include software and/or hardware utilized by the client device 1408 for processing sequencing requests and/or data, as described herein. The client subsystem 1410 may span multiple layers of software and/or hardware. The client subsystem 1410 may be included in a single client device 1408 or may be distributed across multiple client devices 1408.

The client subsystem 1410 may comprise a sequencing application. The sequencing application may be a web application or a native application stored and executed on the client device 1408 (e.g., a mobile application, desktop application). The sequencing application may include instructions that (when executed) cause the client device 1408 to receive data from the sequencing device 614 and/or the server device(s) 1402 and present, for display at the client device 1408, data to the user of the client device 1408.

Multiple client devices 1408 may transmit requests from the client subsystem 1410 to the server subsystem 1404 for performing sequencing services. The client devices 1408 that are transmitting the requests may operate using different versions of a sequencing application for analyzing sequencing data. In one example, the different versions of sequencing applications may support different types of analysis for the same or different types of sequencing devices. The server subsystem 1404 of the server device 1402 may load and execute different versions of a sequencing system to support client sequencing applications operating on different versions of software at the client subsystem 1410. The different versions of the sequencing system may span multiple layers of software and/or hardware of the server subsystem 1404. For example, the different versions of the sequencing system may span multiple software and/or hardware layers of a vertical solution stack.

The client subsystem 1410 may be utilized (e.g., via the sequencing application) to process data, preprocess training data, train and/or execute software that implements AI on one or more computing devices. For example, the client subsystem 1410 may receive inputs from a user of the client device 1408 that cause the client subsystem 1410 to send commands to server devices 1402 and/or imaging systems 1410a, 1410b for training and/or implementing AI features that may be executed in computer-executable instructions stored in memory.

As further illustrated in FIG. 14B, the environment 1400 may include a database 1416. The database 616 may store information for being accessed by the devices in the environment 1400. The server device(s) 1402, the training imaging system 1410a, and/or the production imaging system 1410b may communicate with the database 1416 (e.g., directly or via the network 1412) to store and/or access information.

As indicated by FIG. 14B, the training imaging system 1410a may comprise a device for imaging a biological sample (e.g., nucleic acid material, such as a DNA sample). As described herein, the training imaging system 1410a may be a sequencing system comprising an optical sequencing system, including the example optical sequencing systems of FIGS. 8A-C. The optical sequencing system may include one or more light sources (e.g., LEDs, lasers, and/or other light sources) that may be used to emit light at one or more wavelengths. For example, the training imaging system 1410 may include a two-channel (e.g., green and blue) or four-channel system configured to image a target object using a number of frequencies with which the system is configured. The training imaging system may include detection optical elements, such as lenses, sensors, and/or other detection optical elements may be used to improve the optical detection capabilities of the optical sequencing systems.

The training imaging system 1410a may collect images of a target object, such as a sample container or portion thereof that includes one or more biological samples. For example, the sample container may include a substrate, such as a flow cell or other array, having one or more channels upon which the samples are provided. The samples may include fluorescently tagged nucleotides to be imaged by the optical sequencing system. The training imaging system. 1410a may be configured with a particular objective, or optical element (e.g., lens or lenses) used to gather the light from the target objects, which is measured by an NA.

An example of image collection may include using the optical sequencing system of the training imaging system 1410a to simultaneously capture light emitted by the plurality of fluorescence-tagged nucleotides as the nucleotides are fluorescing responsive to excitation energy emitted from the light source (e.g., laser excitation energy) as a collected image. The image may have one or more dimensions, e.g., a line of pixels or a two-dimensional array of pixels. The pixels may be represented according to one or more values. For example, each pixel may be represented by a single integer (such as an 8-bit integer) that represents intensity of the pixel (such as a greyscale). In another example, each pixel may be represented by a plurality of integers (such as three 24-bit integers) and each of the integers may represent intensity of the pixel according to a respective band of wavelengths (such as respective colors).

The training imaging system 1410a may include an imaging system configured to produce high-resolution images. As described herein, a high-resolution image may be characterized by higher SNR and/or lower frequency content than low-resolution images, such that the high-quality images have sufficient optic detail to make a reliably accurate base call. The training imaging system 1410a may include an imaging system configured to implement various forms of super resolution microscopy, such as SIM imaging systems (e.g., similar to the SIM imaging system 601 shown in FIG. 6), as well as localization-based techniques (e.g., direct stochastic optical reconstruction microscopy (dSTORM); photo-activated localization microscopy (PALM)) and confocal scanning imaging-based approaches (e.g., stimulated emission depletion microscopy (STED)). The training imaging system 1410a may also include one or more of the optical elements of the optical imaging systems of FIGS. 8A-C(e.g., the high NA objective of camera 1 of FIG. 8A or the variable stop elements of FIGS. 8B and 8C used to obtain high resolution images). The training imaging system 1410a may also include an imaging system implementing any one or more of fluorescence imaging, epi-fluorescence imaging, total-internal-reflectance-fluorescence (TIRF) imaging, or a scanning time-delay integration (TDI) imaging.

The training imaging system 1410a may collect images and transmit the images to the server(s) 1402 and/or the client devices 1408 for performing further processing, as described herein. For example, the server(s) 1402 and/or the client devices 1408 may process the images to generate training data and/or train AI of a digital imaging system operating thereon to enhance the optical resolution of the images. In another example, the training imaging system 1410a may perform additional processing locally thereon. For example, the training imaging system 1410a may include a computing device comprising a controller or other processor, as described herein, for performing additional processing of the collected images to generate training data and/or train AI to on a digital processing system to enhance the optical resolution of the images.

The production imaging system 1410b may include an optical sequencing system that is different from or the same as the optical sequencing system included in the training imaging system 1410a. The optical sequencing system of the production imaging system 1410b may include one or more light sources (e.g., LEDs, lasers, and/or other light sources) that may be used to emit light at one or more wavelengths. For example, the production imaging system 1410b may include a two-channel (e.g., green and blue) or four-channel system configured to image a target object using a number of frequencies with which the system is configured. The production imaging system 1410b may use the same or similar chemistry and/or light source configuration (e.g., two-channel, four channel, etc.) as the training imaging system 1410a.

The production imaging system 1410b may collect images of a target object, such as a sample container or portion thereof that includes one or more biological samples. For example, the sample container may include a substrate, such as a flow cell or other array, having one or more channels upon which the samples are provided. The samples may include fluorescently tagged nucleotides to be imaged by the optical sequencing system. The production imaging system 1410b may be configured with a particular objective, or optical element (e.g., lens or lenses) used to gather the light from the target objects, that is measured by an NA.

An example of image collection may include using the optical sequencing system of the production imaging system 1410b to simultaneously capture light emitted by the plurality of fluorescence-tagged nucleotides as the nucleotides are fluorescing responsive to excitation energy emitted from the light source (e.g., laser excitation energy) as a collected image. The image may have one or more dimensions, e.g., a line of pixels or a two-dimensional array of pixels. The pixels may be represented according to one or more values. For example, each pixel may be represented by a single integer (such as an 8-bit integer) that represents intensity of the pixel (such as a greyscale). In another example, each pixel may be represented by a plurality of integers (such as three 24-bit integers) and each of the integers may represent intensity of the pixel according to a respective band of wavelengths (such as respective colors).

The production imaging system 1410b and training imaging system 1410a each include imaging systems that use different optical elements. For example, the production imaging system 1410b may include one or more optical elements that are different than the optical elements in the training imaging system 1410a. The production imaging system 1410b may include optical elements capable of producing images at a lower optical resolution than the training imaging system 1410a, which may reduce the cost associated with the production imaging system 1410b. The production imaging system 1410b may include detection optical elements, such as lenses, sensors, and/or other detection optical elements may produce images with a lower optical resolution than images produced by the training imaging system 1410a. For example, the optical elements in the production imaging system 1410b may have a lower resolving power (e.g., lower NA) than optical elements used in the training imaging system 1410a. For example, the training imaging system 1410a may include one or more of the optical elements of the optical imaging systems of FIGS. 8A-C(e.g., the high NA objective of camera 1 of FIG. 8A or the variable stop elements of FIGS. 8B and 8C used to obtain high resolution images); whereas the production imaging system 1410a implements optical elements of a relatively low resolving power (e.g., low NA objective). As another example, the training imaging system 1410a and may employ an SR imaging system, such as the SIM imaging system 601 shown in FIG. 6, or multiple exposure imaging such as TDI; whereas the production imaging system 1410b employs optical elements of conventional fluorescence microscopy. The use of a different optical sequencing system by the production imaging system 1410b than the training imaging system 1410a may allow the training imaging system 1410a to generate images that are used for training AI to enhance images to at least a threshold optical resolution, while the AI-assisted production imaging system 1410b may obtain images of comparable resolution, but with one or more of: faster sequencing times, reduced photo budget, less complicated and/or less expensive equipment.

In another example in which the production imaging system 1410b and the training imaging system 1410a may use the same or similar optical elements. The production imaging system 1410b and training imaging system 1410a may both employ a SIM imaging system, such as the SIM imaging system 601 shown in FIG. 6, or other SR imaging system. The use of the same or similar optical sequencing system by the production imaging system 1410b and the training imaging system 1410a may allow the training imaging system 1410a to generate images that are used for training AI to enhance images to at least a threshold optical resolution, while the production imaging system 1410b may take less images and cause less damage, as a result.

The production imaging system 1410b may collect images and transmit the images to the server(s) 1402 and/or the client devices 1408 for performing further processing, as described herein. For example, the server(s) 1402 and/or the client devices 308 may process the images using a digital imaging system and/or perform base calling. The server(s) 1402 may implement the trained AI of the digital imaging system to enhance the received images from the production imaging system 1410b and/or perform base calling based on the enhanced images. In another example, the production imaging system 1410b may perform additional processing locally thereon. For example, the production imaging system 1410b may include a computing device comprising a controller or other processor, as described herein, for performing enhancement of the collected images using the trained AI of the digital imaging system to enhance the optical resolution of the images.

As further indicated by FIG. 14B, the server device(s) 1402 may generate, receive, analyze, store, and/or transmit digital data, such as imaging data received from the training imaging system 1410a and/or the production imaging system 1410b. The server device(s) 1402 may comprise a distributed collection of servers where the server device(s) 1402 include a number of server devices distributed across the network 1412 and located in the same or different physical locations. Further, the server device(s) 1402 may comprise a content server, an application server, a communication server, a web-hosting server, and/or another type of server.

As further shown in FIG. 14B, the server device(s) 1402 may include a server subsystem 1404. The server subsystem 1404 may include software and/or hardware utilized by the server device(s) 1402 for processing sequencing requests and/or data, as described herein. The server subsystem 1404 may be included in a single server device 1402 or may be distributed across multiple server devices 1402. The server subsystem 1404 may include a sequencing system that spans multiple layers of software and/or hardware for servicing requests for sequencing services at the server subsystem 1404.

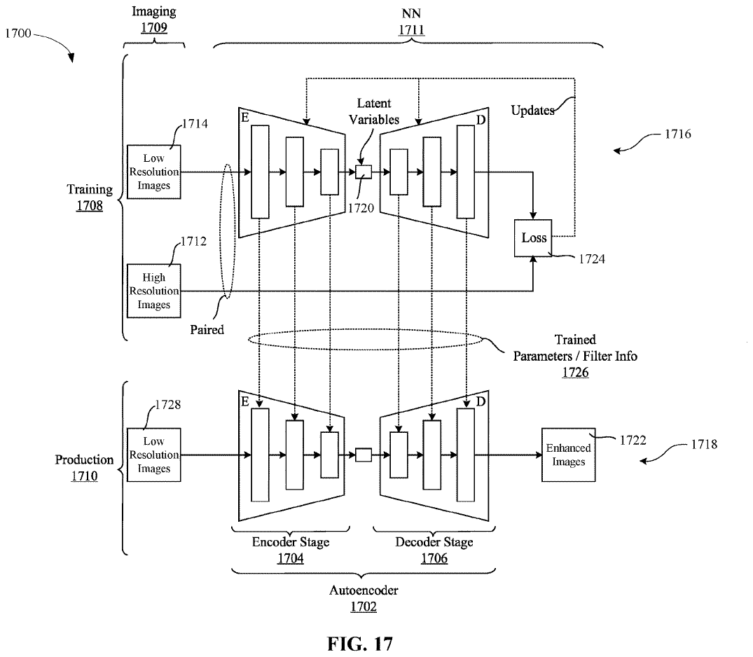

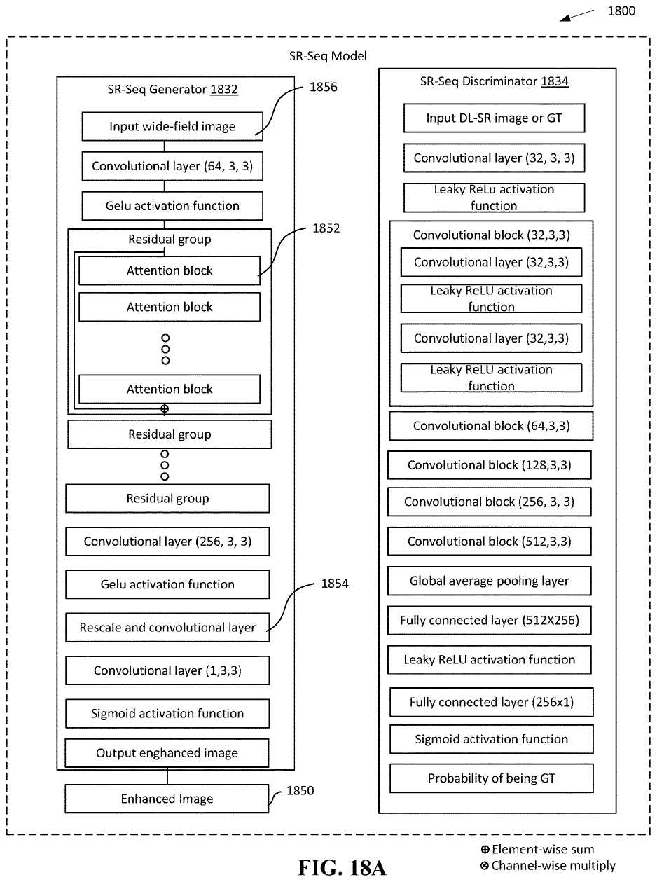

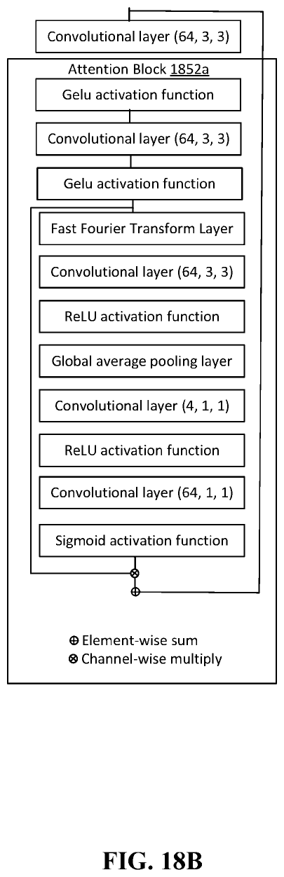

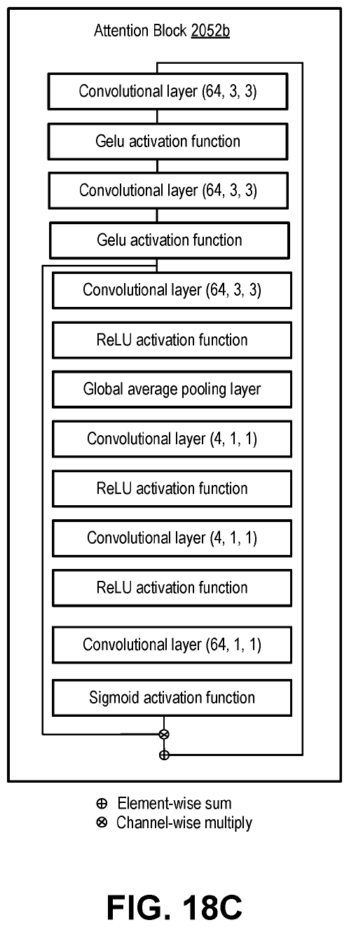

The server subsystem 1404 may include AI or ML that may be trained and/or implemented for analyzing image data for AI-driven resolution enhancement of sequencing images. For example, the server subsystem 1404 may include a digital imaging system that may be implemented to train AI and/or leverage AI for resolution enhancement in sequencing images. An example may include AI-driven resolution enhancement of sequencing images for base calling of SBS. The AI-driven resolution enhancement may be implemented at least in part, for example, based on one or more machine learning techniques such as deep learning using one or more Neural Networks (NNs). Various examples of NNs include Fully-Connected NNs. Various examples of NNs include Convolutional Neural Networks (CNNs) generally (e.g., any NN having one or more layers performing convolution), as well as NNs having elements that include one or more CNNs and/or CNN-related elements (e.g., one or more convolutional layers), and various implementations of Generative Adversarial Networks (GANs) generally, as well as various implementations of Conditional Generative Adversarial Networks (CGANs), cycle-consistent Generative Adversarial Networks (CycleGANs). An example of AI-driven resolution enhancement may be implemented using a CNN-based Autoencoder of FIG. 17, as further described herein. Another example of AI-driven resolution enhancement may be implemented using an SR-Seq model of FIGS. 18A and 18B, as further described herein.

The various examples of NNs further include Recurrent Neural Networks (RNNs) generally (e.g., any NN in which output from a previous step is provided as input to a current step and/or having a hidden state), as well as NNs having one or more elements related to recurrence. The various examples of NNs further include Multi-Layer Perceptron (MLP) neural networks. In some embodiments, a GAN may be implemented at least in part via one or more MLP elements.

Example implementations of a NN architecture include various collections of software and/or hardware elements that collectively perform operations according to the NN architecture. Various NN implementations vary according to machine learning framework, programming language, runtime system, operating system, and underlying hardware resources. The underlying hardware resources variously include one or more computer systems, such as having any combination of Central Processing Units (CPUs), Graphics Processing Units (GPUs), Field Programmable Gate Arrays (FPGAs), Coarse-Grained Reconfigurable Architectures (CGRAs), Application-Specific Integrated Circuits (ASICs), Application Specific Instruction-set Processors (ASIPs), and Digital Signal Processors (DSPs), as well as computing systems generally, e.g., elements enabled to execute programmed instructions specified via programming languages. Various NN implementations are enabled to store programming information (such as code or computer-executable instructions and data) on non-transitory computer readable media and are further enabled to execute the code (e.g., as computer-executable instructions) and reference the data according to programs that implement NN architectures.

Examples of machine learning frameworks, platforms, runtime environments, and/or libraries, such as enabling investigation, development, implementation, and/or deployment of NN's and/or NN-related elements, include TensorFlow, Theano, Torch, PyTorch, Keras, MLpack, MATLAB, IBM Watson Studio, Google Cloud AI Platform, Amazon SageMaker, Google Cloud AutoML, RapidMiner, Azure Machine Learning Studio, Jupyter Notebook, and/or Oracle Machine Learning.

The server subsystem 1404 may be implemented to train one or more NNs of a digital imaging system to recover an enhanced image having a higher optical resolution than the optical resolution of the raw image. The image may be enhanced as if taken at a higher optical resolution, from the lower resolution raw image taken during a sequencing operation. Example techniques to train NNs, such as to determine and/or update parameters of the NNs, include backpropagation-based gradient update and/or gradient descent techniques, such as Stochastic Gradient Descent (SGD), synchronous SGD, asynchronous SGD, batch gradient descent, and mini-batch gradient descent. The backpropagation-based gradient techniques are usable alone or in any combination. For example, stochastic gradient descent is usable in a mini-batch context. Example optimization techniques usable with, e.g., backpropagation-based gradient techniques (such as gradient update and/or gradient descent techniques) include Momentum, Nesterov accelerated gradient, Adagrad, Adadelta, RMSprop, Adam, AdaMax, Nadam, and AMSGrad.

In various embodiments implementing paired image training data as described herein may be employed with any appropriate NN architecture, including CNN architectures, RNN architectures, or CNN-RNN combination architectures. Various architectures and training methods appropriate for use in connection with AI-enhancement as contemplated herein are described, e.g., in U.S. Pub. Nos. 2022/0319639 and US20220067489, each of which is incorporated by reference as if set forth fully herein. In one embodiment, which is illustrated in FIG. 17, the AI for use in SIM reconstruction is a CNN-based architecture having an autoencoder with serially arranged encoder and decoder stages. In one such example, the autoencoder is based in a U-Net architecture as described in Loaf Ronnerberger, Philipp Fischer, and Thomas Brox, U-Net: Convolutional Networks for Biomedical Imaging, arXiv: 1505.04597v1 ((http://) arxiv.org/pdf/1505.04597.pdf), which is incorporated by reference as if set forth fully herein.

FIG. 15 illustrates a system 1500 implementing a GAN for AI-driven resolution enhancement of sequencing images. The upper portion of the figure illustrates a training context 1502 (such as using a laboratory sequencing instrument), and the lower portion illustrates a production context 1504 (such as using one or more sequencing production instruments). From left to right the figure illustrates flow cell 1510, imaging 1520, and NN 1530 sections. The training context NN section 1530 comprises a GAN having Generator (G) 1532, Discriminator (D) 1534, and Pixel-wise Loss function elements 1536. The production context NN section 1504 comprises a Generator (G) 1544 that produces Enhanced Images 1550, In some implementations, the training context NN section and/or the production context NN section use, e.g., one or more convolutional layers to provide training and/or production functions and are therefore sometimes referred to as using CNNs. In various implementations, the training context NN section and/or the production context NN section are based on a transformer architecture, such as including one or more attention mechanisms. In various implementations, the Generator (G) 1532 is based on a convolutional architecture and the Discriminator (D) 1534 is based on a transformer architecture, and vice-versa. The illustration is applicable to training using paired images as well as training using unpaired images.

During training, images of tiles of flow cells 1510 are taken and used to learn parameters (sometimes referred to as weights) of the training context NN. Low-resolution images 1522 (such as taken using reduced, e.g., low, laser excitation power) and high-resolution images 1524 (such as taken using unreduced, e.g., high, laser excitation power) are collected either paired or unpaired, according to various implementations. The collected images (sometimes referred to as training images) are accessed and processed by the training context NN to learn the parameters. The accessing and processing are in accordance with the collected images being paired or unpaired, according to various implementations. All or any portions of the parameters conceptually correspond to an intermediate representation of the high-resolution images 1524 such as with respect to the low-resolution images 1522, e.g., information relating to filters of the training context NN. After training is complete, the intermediate representation is provided to the production context NN for use in enhancing images taken at the low-resolution, as illustrated by Trained Generator Filter Info 1542. The enhanced images 1550, in some scenarios, are of a quality approaching that of images taken at the high-resolution.

During production 1504, singleton images, such as one image for each one of a plurality of tiles of a flow cell 1510, are used for base calling. Sample areas are imaged at the low-resolution, producing production low-resolution images 1526 (sometimes referred to as production images). The production low-resolution images 1526 are accessed by the production context NN. The production context NN adds information based on the Trained Generator Filter Info 1542 to the production low-resolution images 1526 to substantially recover enhanced images 1550, as if the enhanced images were taken at the high-resolution. The enhanced images 1550 are then used for base calling by base caller 1560. Thus, during production, the power level used for imaging is reduced from the unreduced (high) power to the reduced (low) power.

Returning to the training, the training NN Generator (G) 1532 learns to generate so-called fake high-resolution images that closely resemble the (collected) high-resolution images 1524 of the flow cells 1510 and provides them to the training NN Discriminator (D) (conceptually indicated by the arrow labeled Fake 1538). The Discriminator (D) 1534 learns to distinguish between the fake high-resolution images 138 and the collected high-resolution images 1524, Discriminator-sourced updates to parameters of the Generator (G) 1532 and to parameters of the Discriminator (D) 1534 are indicated conceptually in the figure by the dotted arrow Discriminator Updates from the Discriminator (D) to the Generator (G) and the Discriminator (D). Additional updates to parameters of the Generator (G) are indicated conceptually in the figure by the dotted arrow Pixel-Wise Updates from the Pixel-Wise Loss element 1536 to the Generator (G) 1532.

Processing proceeds by initializing parameters of the training NN Generator (G) 1532 and Discriminator (D) 1534, accessing training images 1522 and 1524, propagating forward through the Generator (G) 1532 and the Discriminator (D) 1534, updating the parameters (e.g., via gradient descent and associated back propagation), and iterating the accessing/propagating/updating until an end condition is met. The initializing parameters comprises setting parameters of the Generator (G) 1532 and setting parameters of the Discriminator (D) 1534 to starting values, e.g., randomly within a predetermined range and/or distribution. Alternatively, as described regarding a pretraining implementation, all or any portions of the parameters are pretrained, such as a portion of parameters of the Generator (G) 1532 and/or all the parameters of the Discriminator (D) 1534, The accessing images may comprise accessing collected low-resolution images and high-resolution images.

The propagating forward through the Generator (G) 1532 comprises performing computations based on data of the low-resolution images 1522 (e.g., pixel data values) and the parameters of the Generator (G) 1532. The computations are in accordance with the neural network architecture of the Generator (G) 1532 and produce fake high-resolution images 1538. The propagating images forward through the Discriminator (D) 134 comprises performing computations based on data of the low-resolution images 1522 (e.g., pixel data values) and on data of the fake high-resolution images 1538 (e.g., pixel data) from the Generator (G) 1532. The computations are in accordance with the neural network architecture of the Discriminator (D) 1534 and produce information to update the parameters of the Generator (G) 1532 and the Discriminator (D) 1534.

Conceptually the low-resolution image of a pair of images is processed by the Generator (G) 1532 to create a fake high-resolution image. Then the fake high-resolution image is evaluated by the Discriminator (D) 1534 to output a metric, e.g., a score, that represents whether the Discriminator (D) 1534 believes the image is real or fake. This metric is compared to whether the image is a true or fake high-resolution image to calculate a discriminator loss. In some instances, this process is repeated with a high-resolution image to calculate the discriminator loss. Multiple real high-resolution images, fake high-resolution images, or mix of both, according to various implementations, are processed simultaneously and/or collectively to calculate an aggregate discriminator loss. A pixel-wise loss is computed between the reduced and high-resolution images of the pair. Discriminator updates (related to the discriminator loss) are determined and used to update parameters of the Generator (G) 1532 and the Discriminator (D) 1534. Pixel-wise updates (related to the pixel-wise loss) are determined and used to update parameters of the Generator (G) 1532.

The updating the parameters comprises the Discriminator (D) 1534 evaluating one or more loss functions and determining discriminator-sourced updates to the parameters of the Generator (G) 1532 and the Discriminator (D) 1534, such as via gradient update and/or gradient descent techniques. The updating parameters further comprises the Pixel-Wise Loss element 1536 determining pixel-wise updates to the parameters of the Generator (G) 1532 such as via a pixel-wise loss function and/or via gradient update and/or gradient descent techniques. The pixel-wise loss function compares, on a small region-by-region basis (such as a single pixel or a small number of contiguous pixels), image data of the high-resolution image of a pair of images with a corresponding fake high-resolution image produced by the Generator (G) 1532 based on image data of the low-resolution image of the pair. The high-resolution image is considered the ground truth for the comparison against the fake high-resolution image produced by the Generator (G) 1532. The comparison is via any combination of any one or more of a mean squared error loss and/or any other suitable small region image data comparison technique. The discriminator-sourced updates and the pixel-wise updates are then applied to the parameters of the Generator (G) 1532 and the Discriminator (D) 1534.

In various implementations, the comparison is via any combination of any one or more of a technique that accounts for local area around a particular pixel (e.g., SSI), PSNR, PSF and/or FWHM of a PSF, a Wasserstein-based metric, and variability in intensities for a single sequencing cycle. In various implementations, the comparison is based on intermediary activations of a NN. For example, comparing activation of the 5th layer of a 10-layer discriminator when inputting a real vs fake low-resolution image. Conceptually, comparing intermediary activations corresponds to comparing the similarity of real and fake low-resolution images in a latent space defined by the discriminator.

In some implementations, such as some implementations based on unpaired training images, the Pixel-Wise Loss element and the Pixel-Wise Updates are omitted.

The iterating comprises repeating the accessing images, the propagating images, and the updating the parameters, and the repeating continues until the end condition is met, e.g. one or more completion criteria are met. In various implementations, the iterating is variously conditional on processing each of the high-resolution images at least once, processing each of the low-resolution images at least once, processing a mini-batch quanta of image data, an optimization criterion reaching a corresponding threshold, an error term reaching a corresponding threshold, and any other criteria suitable for determining that sufficient training has occurred for the production context to successfully enhance low-resolution images.

In some implementations represented by FIG. 15, training of the NN is performed at least in part by pretraining the GAN. For example, the Generator (G) 1532 and Discriminator (D) 1534 are trained with high-resolution images before being trained with paired and/or unpaired images that include low-resolution images.

In some GAN pretraining implementations, the Generator (G) has two sections, a conditional section and a generative section. The conditional section receives a low-resolution image as input, processes it through a plurality of layers, and produces a key as an output. The generative section receives the key as input, processes it through a plurality of layers, and maps the key to a unique fake high-resolution image. In some GAN pretraining implementations, the Discriminator (D) is substantially similar to or identical to the Discriminator (D) 1532 illustrated and described with respect to FIG. 15.

Pretraining proceeds as follows. The generative section of the Generator (G) is used. In each iteration, the generative section is seeded with a random key, for example the key is an array of floating-point numbers sampled from a normal distribution. The size of the key is optionally a tunable hyperparameter. The generative section maps the key to a unique fake high-resolution image. The Discriminator (D) differentiates between the fake high-resolution image and a real high-resolution image. The losses from the discriminator are used to update the generative section and the Discriminator (D). The iterations continue until a desired performance is attained.

After the generative section and the Discriminator (D) have been pretrained, the conditional section of the Generator (G) is included, and training of the NN proceeds as described elsewhere herein, with parameters that have been initialized by the pretraining rather than, e.g., randomly. In some implementations, after the inclusion of the conditional section of the Generator (G), subsequent training of the NN in its entirety proceeds end-to-end. In some implementations, after the inclusion of the conditional section of the Generator (G), subsequent training of the NN proceeds by starting with the parameters of the generative section remaining unchanged and then later enabled to change, e.g., for fine-tuning.

In some usage scenarios, pretraining the GAN is motivated as follows. Resolution enhancement using GANs implements a complex process of mapping a low-resolution image to a point in a distribution of high-resolution images, and then mapping that point back to a high-resolution image. Pretraining the GAN enables the Generator (G) to learn the distribution of high-resolution images independent of any influence from the low-resolution images. Conceptually, the Generator (G) becomes proficient by learning simple elements before learning complex elements. The key serves to create a seed for a mapping to a unique image in the learnt distribution. Thus, in some implementations, the output of the conditional section is multi-dimensional. Stated another way, in some implementations, the key is one-dimensional (e.g., a ID array) and in other implementations the key is multi-dimensional.

In some pretraining implementations, the conditional section produces an image, such as a full-resolution image, in addition to the key. The generative section receives the image as well as the key. Pretraining of the generative section is modified to accommodate the image that is received in addition to the key.

In the training context, as shown in FIG. 15, a synthetic path 1523 is indicated from the high-resolution images element 1524 to the low-resolution images element 1522, illustrating optional production of synthetic low-resolution images from high-resolution images. In some implementations, high-resolution images are collected by imaging, e.g., at high NA objective, and low-resolution images are collected by processing one or more of the high-resolution images to produce synthetic low-resolution images, using the synthetic path. See, for example, FIGS. 11A and 12 and associated description. The synthetic low-resolution images are then used in training as if collected by imaging at the low-resolution. In some implementations, the synthetic path is unused, and high-resolution images as well as low-resolution images are collected by respectively imaging at high NA objective and low NA objective. See, for example FIGS. 8A-C, as well as associated descriptions.

In some implementations, such as illustrated explicitly in the figure, the training NN Generator (G) (such as embodied in a laboratory instrument) is distinct from the production NN Generator (G) (such as embodied in a production instrument), and Trained Generator Filter Info is provided from the training NN Generator (G) to the production NN Generator (G). In some implementations, not illustrated, the training NN Generator (G) is used after training as the production NN Generator (G), and the Trained Generator Filter Info is used in situ for production. e.g., a sequencing instrument is used as a dual-purpose laboratory instrument and production instrument.

FIG. 16 illustrates AI-driven resolution enhancement of sequencing images in a system 1600 implementing a cycle-consistent GAN. The upper portion of the figure illustrates a training context 1602 (such as using a laboratory sequencing instrument), and the lower portion illustrates a production context 1604 (such as using one or more sequencing production instruments). From left to right the figure illustrates imaging 1620 and NN 1630 sections. The imaging section 1620 derives image data, e.g., from imaging flow cells (not illustrated for clarity). The training context NN section comprises a training CycleGAN having two pairs of coupled generator and discriminator elements (1632A and 1632B and 1634A and 1634B) and a pair of associated coupled generator and pixel-based loss elements (1636A and 1636B and 1638A and 1638B). The production context NN section comprises a production generator 1642. In some implementations, the training context NN section and/or the production context NN section use, e.g., one or more convolutional layers to provide training and/or production functions and are therefore sometimes referred to as using CNNs. The illustration is applicable to training using unpaired images.

The operating context and operation of the CycleGAN of FIG. 16 are similar to the GAN of FIG. 15. Conceptually, the training and production contexts of FIG. 16 correspond respectively to the training and production contexts of FIG. 15, when trained with unpaired images. After training is complete, trained parameters are provided from the training context to the production context for use in enhancing images taken at the low-resolution, as illustrated by Trained G_{R->U} Filter Info 1640. During production, singleton images taken at the low-resolution are enhanced by the production context to substantially recover enhanced images, as if the enhanced images were taken at the high-resolution. The enhanced images 1650 are usable for base calling. Thus, during production, the power level used for imaging is reduced from the unreduced (high) power to the reduced (low) power.

In some implementations, training proceeds as follows. Each of the coupled generator and discriminator elements determine loss information (1632C and 1634C) and corresponding parameter update information similar to the training context G and D elements of FIG. 15. One of the coupled generator and discriminator elements (1632A and 1632B) attempts to learn how to produce fake high-resolution images from the low-resolution images. The other of the coupled generator and discriminator elements (1634A and 1634B) attempts to learn how to produce fake low-resolution images from the high-resolution images. Each of the coupled generator and pixel-based loss elements determine distance-based loss information and corresponding parameter update information. One of the coupled generator and pixel-based loss elements (1638A and 1638B) determines a distance-based loss function between the high-resolution images (interpreted as ground truth) and the fake low-resolution images after processing back to high-resolution images by the G_{R->U} generator 1638A. The other of the coupled generator and pixel-based loss elements (1636A and 1636B) determines a distance-based loss function between the low-resolution images (interpreted as ground truth) and the fake high-resolution images after processing back to low-resolution images by the G_{U->R} generator 1636A. The parameter update information from the coupled generator and discriminator elements is combined with the parameter update information from the coupled generator and pixel-based loss elements to determine overall parameter updates for the discriminators and the generators, e.g., via a weighting technique.

In some implementations, the two generator elements G_{R->U} 1632A and 1638A in the training context are identical in operation, structure, and/or NN architecture to each other and are also identical in operation, structure, and/or NN architecture to the generator element G_{R->U} 1642 in the production context. For example, the two generator elements G_{R->U} in the training context are implemented in a same ASIC. For another example, the two generator elements G_{R->U} 1632A and 1638A in the training context and the generator element G_{R->U} 1642 in the production context are implemented via a same set of programmed instructions.

In various implementations, performance of NNs (e.g., as described with respect to the GAN of FIG. 15, the CycleGAN of FIG. 16, and/or other NNs described elsewhere herein) is improved by having x and y input dimensions equal to or approximately equal to x and y output dimensions. Another improvement is increasing z input dimension (e.g., by number of images and/or channels input, and/or additional encoding, such as distance to nearest cluster center). Another improvement is collecting and using information from images from multiple sequencing cycles. Other improvements include normalizing whole images (instead of sub-images), performing gradient clipping (e.g., during GAN training), regularizing norm of the gradient (e.g., during GAN training), and discarding edge artifacts (e.g., as introduced by image alignment). For various implementations of CNN-based NNs, performance is improved by using depthwise convolutions, inverted bottlenecks, separating downsampling layers (e.g., instead of a 3×3 convolution with stride two, explicit downsampling with a 2×2 convolution with stride two), increasing kernel sizes, preferentially using layer normalization instead of batch normalization, preferentially using GELU instead of ReLU, and/or reducing layers used (e.g., fewer activation layers and/or fewer normalization layer). For various implementations of transformer based NNs, performance is improved shifting windows between attention blocks to enable encoding spatial information between patches. For some PatchGAN implementations, adaptations to attend to high spatial frequencies are beneficial.

FIG. 17 is an example of an AI architecture 1700 that may be implemented for AI-driven resolution enhancement of sequencing images using a digital imaging system. An example of the AI architecture 1700 may use a U-Net architecture. The AI architecture 1700 may include an autoencoder 1702 having an encoder stage 1704 and a decoder stage 1706. The upper portion of the figure illustrates a training process 1708 (e.g., using a laboratory sequencing by synthesis instrument), and the lower portion illustrates a production process 1710 (e.g., using one or more sequencing by synthesis production instruments).

FIG. 17 illustrates imaging portion 1709 and NN portion 1711 of the training process 1708 and the production process 1710. In the imaging portion 1709 of the training process 1708, images may be generated by optical sequencing systems and/or digital imaging systems, as further described herein. For example, an optical sequencing system may include an optical sequencing system configured to generate high resolution images 1712 (e.g., SR images). In an example, the high-resolution images may be SIM images.

Some implementations of AI-driven resolution enhancement of sequencing images are based on supervised training (e.g., directed to an autoencoder or some variations of a GAN), using so-called paired images for image-to-image translations. One image of the pair may be a high-resolution image 1712 generated from the optical elements of the optical sequencing system. The other image of the pair may be a low-resolution image generated from the optical elements of the optical sequencing system and/or generated by the digital imaging system. For example, the low-resolution image 1714 may be a low-resolution image that is generated by the digital imaging system from the high-resolution image 1712, as described herein. The low-resolution image 1714 may be degraded to simulate one or more low-resolution conditions. The low-resolution images 1714 may be generated by the digital imaging system as training data as input for training the NN 1716 of the autoencoder. The low-resolution training image data may yield a corresponding set of low-resolution images.

The autoencoder 1702 may have an encoder stage 1704 and/or a decoder stage 1706 that are trained during the training process 1708. The encoder stage 1704 and/or the decoder stage 1706 may include one or more layers of the NN. The one or more layers may include one or more processing layers (e.g., convolutional layers), activation layers, and/or pooling layers of successively smaller dimensions, collectively enabled to compress representation of low-resolution images to a relatively small representation (as illustrated conceptually by the Latent Variables element 1720). The decoder stage 1706 may include one or more layers (e.g., similar to those of the encoder stage 1704) but dimensionally organized in “reverse” compared to the layers of the encoder stage 1704, arranged in successively larger dimensions, so as to conceptually uncompress the latent variable information into a full-sized reconstructed image (e.g., corresponding to all or substantially all of a field of view of an imager) or alternatively a reconstructed image sized corresponding to input provided to the encoder stage 1704 (e.g., corresponding to one of a plurality of small patches of an image). In one preferred example, the autoencoder model includes one or more skip connections that allow feature representations, e.g., lower frequency content data, to pass through any particular layer for which further processing is inappropriate or unnecessary.

During the training process 1708, the low-resolution images 1714 be used to learn parameters (sometimes referred to as weights and/or biases) of the NN 1716. All or any portions of the parameters conceptually correspond to an intermediate representation of the high-resolution images such as with respect to the low-resolution images, e.g., information relating to filters of the NN 1716. The trained NN 1716 learns to generate enhanced images 1722 that closely resemble the (real) high resolution images 1712 of the target objects. The training may be performed by initializing parameters of the NN 1716, accessing the high-resolution images 1712 cycles of a sequencing run, generating the low-resolution images 1714 corresponding to the high-resolution images 1712, inputting the low-resolution images 1714, calculating the loss via a loss function 1724 (e.g., via gradient descent and associated back propagation), updating the parameters, and iterating the process until an end condition is met. For example, the end condition for training may include when validation loss stops decreasing or is decreasing by less than a threshold amount.

After training is complete, the intermediate representation is provided to the NN 1718 of the production process 1710 for use in generating enhanced images 1722 from images taken at a lower optical resolution (e.g., low-resolution images 1728), as illustrated by trained parameters/filter info 1726. The enhanced images, in some scenarios, are of a quality approaching that of high-resolution images 1712 (e.g., SIM or SR images).

During the production process 1710, the enhanced images 1722 may be used for base calling. For example, singleton images, such as one image for each one of a plurality of tiles of a flow cell, may be used for base calling. The NN 1718 utilized in the production process may be implemented by a digital imaging system to add information to the low-resolution images 1728 that are taken on an optical sequencing system. The optical sequencing system that is used in the production process 1710 may have the same or different optical elements as the optical sequencing system used in the training process 1708, as further described herein.

In some implementations, the NN 1716 that is used in the training process 1708 (e.g., as embodied in a laboratory instrument) may be distinct from the NN 1718 that is used in the production process 1710 (e.g., as embodied in a production instrument), and trained parameters/filter information of the antoencoder is provided from the training NN 1716 to the production NN 1718. In some implementations, the training NN 1716 may be used after training as the production NN 1718. For example, an instrument may be used as a dual-purpose laboratory instrument and production.

FIG. 18A illustrates a system 1800 implementing an SR-Seq model for AI-driven resolution enhancement of sequencing images. The SR-Seq model 1800 may be trained and/or implemented similarly to the GAN illustrated in FIG. 15. For example, the SR-seq model may include a NN capable of being trained in a training context (e.g., similar to the training context 1502 of FIG. 15) and/or implemented in a production context (e.g., similar to the production context 1504 of FIG. 15).

As shown in FIG. 18A, the SR-Seq model 1800 may include an SR-Seq generator 1832 and/or an SR-Seq discriminator 1834. In the production context, the SR-Seq model may comprise the SR-Seq generator 1832 that produces or outputs one or more enhanced images 1850. As shown in FIG. 18A, in some implementations, the SR-Seq model may use one or more convolutional layers to provide training and/or production functions and are therefore sometimes referred to as using CNNs. The training context and/or the production context in which the SR-Seq model is used may be based on a transformer architecture, such as including one or more attention mechanisms or blocks 1852. In various implementations, the SR-Seq generator 1832 may be based on a convolutional architecture and the SR-Seq discriminator 1834 may be based on a transformer architecture, and vice-versa.

As further shown in FIG. 18A, the SR-seq generator 1832 may receive an image as input. The input may be, for example, a wide-field image. The SR-seq may pass image data from the image through one or more layers to generate an output of an enhanced image at 1850. The SR-seq generator 1832 may include one or more attention blocks 1852, or attention layers. The SR-seq generator 1832 may include a rescale and convolutional layer 1854. This rescale and convolutional layer 1854 may be an upsampling layer, which may increase the size of the image to have a higher digital resolution.

FIG. 18B illustrates an example of an attention block 1852 that may be implemented in the SR-Seq generator 1832. As shown in FIG. 18B, the attention block 1852 may each use one or more convolutional layers to provide training and/or production functions for generating image data. The one or more convolutional layers may enable the SR-seq generator 1832 to identify and/or generate features in the spatial domain for providing spatial attention (e.g., via a spatial attention map or feature map) to the SR-seq generator 1832. As also shown in FIG. 18B, the attention blocks 1852a may each use one or more Fast Fourier Transform (FFT) layers to provide training and/or production functions for generating image data. The one or more FFT layers may enable the SR-seq generator 1832 to identify and/or generate features in the Fourier domain for providing Fourier channel attention (e.g., via a Fourier channel attention map or feature map) to the SR-seq generator 1832. The Fourier channel attention may allow the SR-seq generator 1832 to rescale each feature map according to the contributions from frequency components contained in the power spectrum. In contrast, the spatial attention may utilize the average intensity of the feature maps, which may be equivalent to a zero frequency.

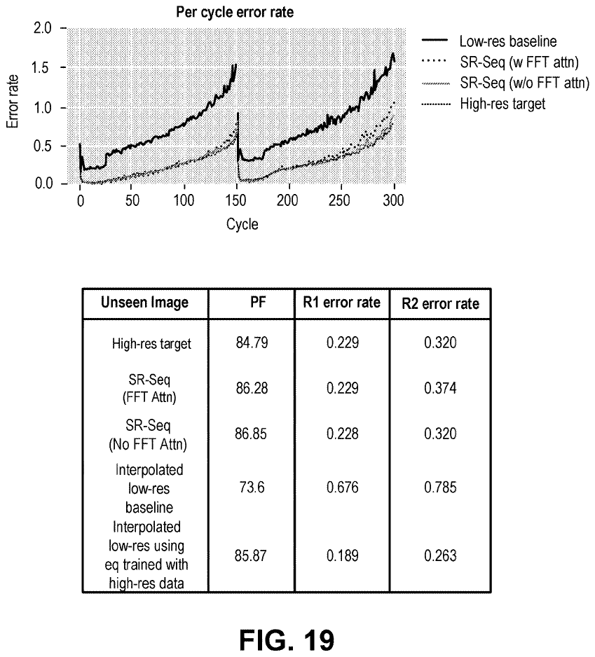

FIG. 18C illustrates another example of an attention block 1852b that may be implemented in the SR-Seq model. As shown in FIG. 18C, the attention blocks 1852b may each use one or more convolutional layers to provide training and/or production functions for generating image data. The one or more convolutional layers may enable the SR-seq generator 1832 to identify and/or generate features in the spatial domain for providing spatial attention (e.g., via a spatial attention map or feature map) to the SR-seq generator 1832. As also shown in FIG. 18C, the attention block 1852b may have the FFT layer removed or fail to implement the FFT layer, such that the attention block 1852b. The structure of a flow cell or other surface image captured by the target image data may be relatively well defined. As a result, the spatial frequencies of the image being input into the SR-seq generator 1832 may also be well defined, such that the point sources from which spatial frequencies are determined during training may be similar to the location of the point sources from which the spatial frequencies would be located during production (e.g., a nanowell or less). Thus, the attention block 1852 may be implemented with a relatively high accuracy (e.g., as shown in FIG. 19) in the absence of an FFT layer or other layer providing Fourier channel attention. Additionally, the lack of an FFT layer or other layer providing Fourier channel attention may increase the processing efficiency and performance of sequencing runs (e.g., about a 25% to 30% reduction in FLOPS, which is about 14 times faster) during production and may increase the time or speed of training (e.g., 4x increase in training). While examples are provided herein for AI driven resolution enhancement using NN-based systems, the AI driven resolution enhancement may be implemented, at least in part, using non-NN based systems and/or algorithms.

FIG. 19 is a graphical depiction comparing the results of different types of NN-based and non-NN-based algorithms/AI models that have been trained using HR-LR paired images, as described herein. As shown in FIG. 19, different images were generated from which base calling may be performed. The images included low-resolution baseline images, high-resolution images generated using the SR-seq model with Fourier attention, the SR-seq model without Fourier attention, an interpolated low-resolution image generated using a non-NN based systems trained with high-resolution data, and/or the high-resolution target image. Each of the models were trained and tested on the same targets. The high-resolution target image is a SIM image. The low-resolution baseline image is generated from the SIM image, as described herein.

The quality of the models being indicated in FIG. 19 is measured using a per cycle error rate and a pass filter (PF), or a filter quality threshold. For example, the PF may be a threshold that is met based on a ratio of the brightest base intensity divided by the sum of the brightest and second brightest base intensities. Clusters of reads may pass the PF if no more than I base call has a ratio value below 0.6 in the first 25 cycles. This filtration process may remove the least reliable clusters from the image analysis results. The ratio value is indicated in the table in FIG. 19.

As shown in FIG. 19, the error rate of the base calls using the high-resolution images generated by the SR-seq are comparable to, and sometimes outperform, the high-resolution target image generated using SIM techniques. The non-NN based system outperformed both the NN-based SR-seq models, as well as the SIM image, with regard to error rate of base calls. The PF ratio was highest in the SR-Seq models, but the non-NN based system also outperformed the SIM image.

In one aspect, systems and methods are described for image processing at low resolving power. Methods are provided for training a model to analytically generate high-resolution images, as if obtained using a high Numerical Aperture (NA) objective, from target signals captured under low resolution. In one example, a set of parameters are trained using a training set of data having paired images of high-resolution images obtained from a biological sample at a high NA and low NA. The trained set of parameters may be configured as one or more filters that enable a production model to recover enhanced images, as if obtained using high Numerical Aperture (NA) objective, from unenhanced images obtained using a low NA objective. Analytical enhancements herein may be implemented in lieu of expensive lens and other optic element upgrades otherwise required to achieve matching resolution.

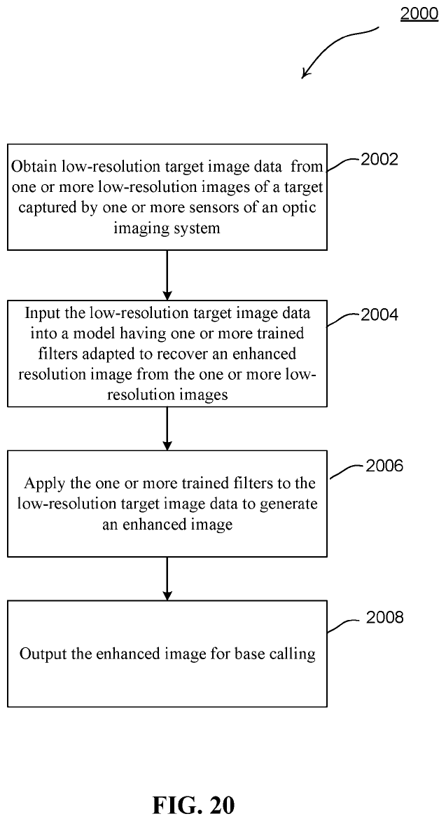

FIG. 20 is a diagram illustrating an example process 2000 of producing an enhanced resolution images from low-resolution images captured in a sequencing operation in production. One or more portions of the process 2000 may be performed by one or more computing devices. For example, the one or more portions of the process 2000 may be performed by one or more server devices and/or one or more imaging systems. For example, one or more portions of the process 2000 may be implemented by a digital imaging system operating on one or more computing devices, One or more portions of the process 2000 may be stored in memory as computer-readable or machine-readable instructions that may be executed by a processor of the one or more computing devices. Though portions of the process 2000 may be described herein as being performed by a digital imaging system operating on one or more computing device, the process 2000 may be performed by another system operated by a computing device or distributed across multiple computing devices.

At 2002, low-resolution target image data may be obtained from one or more low-resolution images of a target captured by one or more sensors of an optic imaging system. At 2004, the low-resolution image data may be input into a model having one or more trained filters adapted to recover an enhanced resolution image from the one or more low-resolution images. The trained filters may be adapted from parameters refined from training data in a training model. For example, the training data may include high-resolution target image data from one or more training images of a target for each of a plurality of targets captured under high resolution. The high-resolution target image data yields a set of high-resolution images that may represent groundtruth data for the training model. The training data may include low-resolution training image data processed from the set of high-resolution images. Processing may include synthetically degrading the set of high-resolution images to simulate one or more low-resolution conditions. The resulting low-resolution training image data may yield a set of low-resolution images corresponding pairwise to at least a portion of the set of high-resolution images. In production, at 2006, the one or more trained filters may be applied to the low-resolution target image data to generate an enhanced image, which, at 2008, may then be output for base calling.

The model may be trained for a different predefined number of cycles in a sequencing run. Early cycle images in a sequencing run may be of better quality than later cycles, due to the photo damage that may be caused from the images taken over the sequencing run. The model may be trained differently at different cycles in the sequencing run. For example, a number of images that are taken earlier in a sequencing run (e.g., within a predefined number of cycles) may be lower than a number of images that are taken later in the sequencing run, as the image data may be of a higher quality and may preserve the target samples due to the reduced number of images taken earlier on in the sequencing run.

In one aspect, systems and methods are described for diffraction limited image processing of high-density samples of biopolymeric materials using standard fluorescence microscopy. Methods are provided for training a model to analytically generate high-resolution images from target signals captured under low resolution in lieu of Fourier transform processing associated with Structured Illumination Microscopy. In one example, a set of parameters are trained using a training set of data having paired SIM reconstructed high-resolution images and corresponding pre-processed low-resolution images. The trained set of parameters may be configured as one or more filters that enable a production model to recover enhanced images, as if taken under high resolution conditions, from unenhanced images taken under low resolution conditions using conventional (i.e., non-SIM) microscopy. AI-driven resolution enhancement as provided herein requires fewer computational steps than Fourier transform processing and produces images of comparable high-resolution to SIM without the need for multiple structured image exposures per target. In that regard, the systems and methods herein for AI-driven enhancement of low-resolution images enable optimized diffraction-limited imaging comparable to image resolution obtained in SIM and other SR methods, but with faster sequencing times, reduced photo budget, and less expensive equipment.

Certain embodiments provide imaging systems and methods of resolving biological samples on a high density patterned flow cells with nanofeatures (i.e., nanowells, nanopedestals, etc.) at a pitch of about 600 nm or less, about 500 nm or less, 400 nm or less; or about 350 or less. Certain embodiments provide imaging systems and methods of resolving biological samples on a high density patterned flow cells with nanofeatures having a diameter of about 350 nm or less, about 325 nm or less, about 300 nm or less. Certain embodiments provide imaging systems and methods of resolving biological samples on a high density patterned flow cells with nanofeatures having a depth of about 350 nm or less, about 300 nm or less, about 250 nm or less, or about 225 nm or less. Certain embodiments provide imaging systems and methods of resolving high or low density patterned flow cells or random non-patterned flow cells without having/using one or more of SIM, a high-numerical aperture objective, long exposure times, multiple exposures, or combinations thereof. For example, the AI-model can be trained with data obtaining on systems with having/using one or more of SIM, a high-numerical aperture objective, long exposure times, multiple exposures, or combinations thereof, and the AI-model can be imported onto systems that do not have/use one or more of SIM, a high-numerical objective aperture, long exposure times, multiple exposures, or combinations thereof. While flow cell has been described as including a pattern of nanowells to provide reaction sites, methods disclosed herein may be performed on a variety of different flow cell architectures, including a number of flow cells commercially available from Illumina, Inc. (San Diego, Calif.). In some examples, the flow cells can be configured with a functionalized substrate comprising an unstructured planar surface. In other examples, the flow cells can be configured with functionalized features in a surface. The features can be present in any of a variety of desired formats, including wells, pits, channels, ridges, raised regions, pegs, posts or the like. Example sites include wells that are present in substrates used for commercial sequencing platforms sold by 454 LifeSciences (a subsidiary of Roche, Basel Switzerland) or Ion Torrent (a subsidiary of Life Technologies, Carlsbad Calif.). Other substrates having wells include, for example, etched fiber optics and other substrates described in U.S. Pat. Nos. 6,266,459; 6,355,431; 6,770,441; 6,859,670; 6,210,891; 6,258,568; 6,274,320; U.S. Patent Pub. No. 2009/0026082 A1; U.S. Patent Pub. No. 2009/0127589 A1; U.S. Patent Pub. No. 2010/0137143 A1; U.S. Patent Pub. No. 2010/0282617 A1 or PCT Publication No. WO 00/63437, each of which is incorporated herein by reference in its entirety. In several cases, the substrates are exemplified in these references for applications that use beads in the wells. The well-containing substrates are particularly apt for immobilizing clustered beads of the disclosure into an array. In some examples, wells of a substrate can include gel material as set forth in U.S. Pat. No. 9,512,422, which is incorporated herein by reference in its entirety.

The functionalized features of the flow cell can be metal features on a non-metallic surface such as glass, plastic or other materials exemplified above. A metal layer can be deposited on a surface using methods known in the art, such as wet plasma etching, dry plasma etching, atomic layer deposition, ion beam etching, chemical vapor deposition, vacuum sputtering or the like. Any of a variety of commercial instruments can be used as appropriate including, for example, the FLEXAL®, OPAL™, IONFAB® 300plus, or OPTOFAB® 3000 systems (Oxford Instruments, UK). A metal layer can also be deposited by e-beam evaporation or sputtering as set forth in Thornton, Ann. Rev. Mater, Sci. 7:239-60 (1977), which is incorporated herein by reference in its entirety. Metal layer deposition techniques, such as those exemplified above, can be combined with photolithography techniques to create metal regions or patches on a surface. Example methods for combining metal layer deposition techniques and photolithography techniques are provided in U.S. Pat. No. 8,778,848, which is incorporated herein by reference in its entirety.

An array of functionalized features can appear as a grid of spots or patches. The features can be located in a repeating pattern or in an irregular non-repeating pattern, Particularly useful patterns are hexagonal patterns, rectilinear patterns, grid patterns, patterns having reflective symmetry, patterns having rotational symmetry, or the like. Asymmetric patterns can also be useful. The pitch can be the same between different pairs of nearest neighbor features or the pitch can vary between different pairs of nearest neighbor features.

While this disclosure has been described in terms of certain embodiments and generally associated methods, alterations and permutations of the embodiments and methods will be apparent to those skilled in the art. Accordingly, the above description of example embodiments does not constrain this disclosure. Other changes, substitutions, and alterations are also possible without departing from the spirit and scope of this disclosure.

What is claimed:

1. A method of training a model to produce an enhanced resolution image from a low-resolution image in a sequencing operation, the method including:
obtaining high-resolution training image data from one or more images of a target for each of a plurality of targets, wherein the high-resolution target image data yields a predefined set of high-resolution images for a number of cycles of a sequencing run, and wherein the target comprises a biological sample;
generating low-resolution training image data from the one or more images captured of the target during the number of cycles of the sequencing run, wherein the one or more images are synthetically degraded to simulate one or more low-resolution conditions, and wherein the low-resolution training image data yields a predefined set of low-resolution images corresponding pairwise to at least a portion of the predefined set of high-resolution images for the number of cycles of the sequencing run;
training parameters of the model using the low-resolution training image data and the high-resolution target image data,
wherein the parameters are trained to extract features of the low-resolution training image data for predictively generating a set of enhanced images of comparable resolution to corresponding high-resolution images of the set of high-resolution images, and
outputting the trained parameters of the model,
wherein the trained parameters are configurable into one or more trained filters for recovering an enhanced production image from one or more low-resolution production images of a production target, and
wherein the enhanced production image has an optical resolution above a prescribed threshold required in a sequencing operation.

2. The method of claim 1, wherein the high-resolution target image data comprises signal data processed from a plurality of signals emitted by each of the plurality of targets under excitation from a light source.

3. The method of claim 2, wherein each target comprises a plurality of nucleic acid materials captured on a portion of a flow cell substrate within a field of view of the one or more sensors.

4. The method of claim 3, wherein the flow cell substrate comprises a pattern of nanowells, wherein the average pitch is 400 nm or less.

5. The method of claim 3, wherein the one or more images of a target for each of a plurality of targets comprises six or more structured images captured by one or more sensors in a spatial domain from three or more phase displacements with sinusoidally varying illumination patterns at two or more angles relative to an imaging system comprising the one or more sensors;
wherein obtaining high-resolution target image data from one or more images of a target for each of a plurality of targets comprises, for each target,
generating frequency domain content based, at least in part, on frequency content engendered by the sinusoidally varying illumination patterns and
merging frequency domain content of the six or more structured images into high-resolution target image data yielding a reconstructed high-resolution image;
wherein preprocessing low-resolution training image data from the one or more images captured under high resolution conditions comprises, for each target,
averaging the frequency content engendered by the sinusoidally varying illumination pattern in four or less of the six or more structured images into low-resolution target image data to yield a low-resolution image.

6. The method of claim 5, wherein the two or more angles comprise angles at two or more of 0°, 60°, 90°, 120°, and 240°.

7. The method of claim 5, wherein the four or less of the six or more structured images comprise three structured images captured from three phase displacements at one angle.

8. The method of claim 5, wherein the one or more low-resolution conditions comprises operating beyond a diffraction limit of the imaging instrument.

9. The method of claim 5, wherein the high-resolution training image data is obtained using a structured illumination microscopy (SIM) subsystem, the method further comprising:
storing the trained parameters of the model;
removing or replacing the SIM subsystem after the parameters of the model are trained; and
using the parameters of the model to output an enhanced resolution image for base calling.

10. The method of claim 9, further comprising:
exporting the trained parameters from a first imaging system to a second imaging system, wherein the first imaging system includes the SIM subsystem, wherein the second imaging system does not include the SIM subsystem, and wherein the parameters of the model are used by the second imaging system to output the enhanced resolution image.

11. The method of claim 9, wherein the parameters of the model are trained to generate high-resolution images that simulate SIM images using the SIM subsystem.

12. The method of claim 3, wherein the one or more low-resolution conditions comprises operating using a lens having a low Numerical Aperture (NA) objective value insufficient to permit the imaging systems to resolve wavelengths of adjacent targets.

13. The method of claim 1, wherein the model is a neural network (NN).

14. The method of claim 12, wherein the neural network comprises at least one attention layer, wherein each attention layer does not include a Fourier Transform layer.

15. The method of claim 1, wherein the model is a non-NN model.

16. The method of claim 14, wherein the model comprises coefficients for at least one lookup table (LUT).

17. A method of producing an enhanced resolution images from low-resolution images captured in a sequencing operation in production, the method including:
obtaining low-resolution target image data from one or more low-resolution images of a target captured by one or more sensors of an optic imaging system;
inputting the low-resolution target image data into a model, wherein the model comprises one or more trained filters for recovering an enhanced resolution image from the one or more low-resolution images;
wherein the one or more trained filters are configured from parameters refined from training data comprising:
high-resolution target image data from one or more images of a target for each of a plurality of targets captured under high resolution, wherein the high-resolution target image data yields a set of high-resolution training images;
low-resolution training image data processed from the set of high-resolution training images such that the set of high-resolution training images are synthetically degraded to simulate one or more low-resolution conditions, wherein the low-resolution training image data yields a set of low-resolution training images corresponding pairwise to the set of high-resolution training images;
outputting the enhanced resolution image for base calling.

18. The method of claim 17, wherein the high-resolution target image data comprises signal data processed from a plurality of signals emitted by each of the plurality of targets under excitation from a light source.

19. The method of claim 18, wherein the target comprises a plurality of nucleic acid materials captured on a portion of a flow cell substrate within a field of view of the one or more sensors.

20. The method of claim 18, wherein the one or more images of a target for each of a plurality of targets comprises six or more structured images captured by one or more sensors in a spatial domain from three or more phase displacements with sinusoidally varying illumination patterns at two or more angles relative to an imaging system comprising the one or more sensors;
wherein the high-resolution target image data from one or more images of a target for each of a plurality of targets is obtained, for each target, by
generating frequency domain content of the six or more structured images based, at least in part, on frequency content engendered by the sinusoidally varying illumination patterns and
merging frequency domain content of the six or more structured images into high-resolution target image data yielding a reconstructed high-resolution image;
wherein the low-resolution training image data is processed, for each target, by
aligning the frequency content engendered by the sinusoidally varying illumination pattern in four or less of the six or more structured images into low-resolution target image data and
summing the aligned frequency content to yield a low-resolution image.

21. The method of claim 20, wherein the two or more angles comprise angles at two or more of 0°, 60°, 120°, and 240°.

22. The method of claim 20 wherein the four or less of the six or more structured images comprises two structured images captured from one of the three or more phase displacements with sinusoidally varying illumination patterns at two of the two or more angles.

23. The method of claim 20, wherein the one or more low-resolution conditions comprises operating beyond a diffraction limit of the imaging instrument.

24. The method of claim 17, wherein the one or more low-resolution conditions comprises operating using a lens having a low Numerical Aperture (NA) objective value insufficient to permit the imaging systems to resolve wavelengths of adjacent targets.

25. An instrument comprising a processor implementing the trained filter of claim 17, wherein the instrument is configured to obtain, as an input, low-resolution target image data from one or more low-resolution images of a target captured by one or more sensors of an optic imaging system and recover from the low-resolution target image data, via the trained filter, an enhanced resolution image, as an output, for use in base calling.

26. The instrument of claim 25, wherein the instrument is an optic sequencing device.
